(19) United States
(12) Patent Application Publication
(10) Pub. No.: US 2004/0113378 A1
(43) Pub. Date: Jun. 17, 2004

(54) Gravity driven steerable vehicle

(76) Inventors: Frederic L. Way II, Hebron, CT (US); Steven K. Walton, Townshend, VT (US); David L. Newton, Keene, NH (US)

Correspondence Address: George W. Dishong Esq., DISHONG LAW OFFICE, 40 Bryant Road, Jaffrey, NH, 03452, US

(21) Appl. No.: 10/659,730

(22) Filed: Sep. 10, 2003

Related U.S. Application Data
(63) Continuation-in-part of application No. 09/797,406, filed on Mar. 1, 2001, now Pat. No. 6,672,602.
Application No. 09/797,406 is a continuation-in-part of application No. 09/686,235, filed on Oct. 11, 2000.
Application No. 09/686,235 is a continuation-in-part of application No. 09/071,523, filed on May 1, 1998, now Pat. No. 6,276,700.

(51) Int. Cl. B62K 13/00

(52) U.S. Cl. 280/7.12

(57) ABSTRACT

A gravity driven steerable vehicle having wheels, or skis or a combination of wheels and skis for recreational use, most particularly on surfaces such as pavement, artificial hard-pack turf, mountain slopes, dirt roads, grass and hard-packed or non-packed snow. The vehicle has at least three (3) but preferably four (4) wheels, or skis or a combination of wheels and skis which may or may not be on independent axles one from the other and which may or may not be each independently shock suspended. There is also a steering mechanism for steering the vehicle and a driver compartment portion for containing a driver of the vehicle in a prone face-down and face-forward position. The vehicle is steerable by the driver from the substantially prone face-down and face-forward position. The mechanism for suspension of the wheels and/or skis is configured to provide precise control in turns especially the carving of turns, by the skis, while descending on snow covered terrain. The attitude of the skis relative to the snow surface changes upon initiation of a turn and while in the turn to increase the edgeing of the skis thereby enhancing the turning characteristics of the vehicle. The vehicle may further have a braking system for slowing or stopping the vehicle and a harness apparatus for harnessing the driver onto and into the vehicle. The vehicle may further have means for causing the vehicle to be non-moving when the vehicle is unoccupied by a rider. The means for causing non-movement of unoccupied vehicle is at least one movement-limiting system for causing non-movement of an unoccupied vehicle or combination of any or all movement-limiting systems selected from a group consisting of weight detection of objects occupying the rider riding surface, temperature detection of objects occupying the rider riding surface, electrical current flow detection of level of current flow within at least two skin contact points associated with the rider and an activation control mechanism for activating and deactivating the means for causing the vehicle to be non-moving. The special design of rider support is a rider riding surface on the chassis top side configured to cause a rider on the rider riding surface to be oriented in a substantially prone, face down, face forward position wherein the rider riding surface has particular geometric features which provides for a slight elevation in the upper body supporting section, lower positioned and angled thigh to knee region and a slightly elevated—relative to the knee region—ankle and foot support region. There may also be included the rider riding surface with a removeable cover having a storage region below the chest pressure region of the surface.

### CROSS-REFERENCE TO RELATED APPLICATIONS

This application claims the benefit of U.S. Provisional Application No. 60/045,490 filed May 2, 1997, U.S. Provisional Application Nos. 60/159,465, filed Oct. 13, 1999, and 60/186,185, filed Mar. 1, 2000. This application is a continuation-in-part of U.S. application Ser. No. 09/797,406, filed Mar. 1, 2001, which is a continuation-in-part of U.S. application Ser. No. 09/686,235 filed Oct. 11, 2000, which is a continuation-in-part of U.S. application Ser. No. 09/071,523, filed May 1, 1998, now U.S. Pat. No. 6,276,700B1, issued Aug. 21, 2001.

### BACKGROUND OF THE INVENTION

This invention most generally relates to gravity driven vehicles such as downhill racing carts. More particularly this invention relates to maneuverable, steerable gravity driven vehicles. Even more particularly, the invention relates to a stable, durable gravity driven vehicle which is steerable, has at least two wheels or two skis or a combination of wheels and skis and at least one brake, is ridden in a prone, face down, face forward position and which may be ridden on varied surface terrain such as dirt, grass or snow. Most particularly this invention relates to the mechanism for suspension of the wheels and/or skis which is configured to provide precise control in turns especially the carving of turns, by the skis, while descending on snow cover. Even more and most particularly this invention relates to means for causing the gravity driven type of vehicle to be non-moving when the vehicle is unoccupied by a rider. It is clear and noted that wherein the means for causing non-movement of unoccupied vehicle is at least one movement-limiting system for causing non-movement of an unoccupied vehicle or combination of any or all movement-limiting systems selected from a group consisting of weight detection of objects occupying the rider riding surface, temperature detection of objects occupying the rider riding surface, electrical current flow detection of level of current flow within at least two skin contact points associated with the rider and an activation control mechanism for activating and deactivating the means for causing the vehicle to be non-moving.

Although there are various patents disclosing embodiments for devices which permit movement over a surface, the following patents known to the inventors hereof, do not in any manner suggest or teach the Gravity Driven Steerable Wheeled or ski equipped Vehicle disclosed and claimed by applicants in the instant application for patent.

U.S. Pat. No. 3,887,210 to Funke discloses a four wheeled, downhill racing cart with a steel frame and a driver's seat mounted on the frame for use on various surfaces. The rider of the cart must sit in an upright position with feet forward. The cart is steered by applying pressure with the feet to pedals attached to the front axle assembly. There is a braking mechanism which is triggered by leaning forward in the seat and engaging a braking member which is suspended from the seat frame. When the seat is leaned forward and the braking member is engaged, a plate is lowered to contact the ground surface and apply braking by frictionous contact with the ground. A rubber pad is fastened to the underside of the braking plate for braking engagement with the surface over which the cart is traveling. The cart does have handle bars, however, they are not used at all for steering control of the vehicle. The handles appear to be used for holding on and keeping the rider with the cart. The device also has carry hooks on the front handle assembly for towing of the device to the starting area. Additionally, the device can be fitted with a “roll-bar” attachment.

U.S. Pat. No. 4,098,519 to Reid, Jr. device looks most like the known “flexible flyer” type of snow sled. This wheeled sled has four wheels and may be ridden on a variety of surfaces in a sitting or prone position. The body of the device is not inclined and is composed of several, separate, wooden slats. There are slots in the body of the device for gripping when riding in a seated position. However, the prone position would be preferred in order for the user to operate the two hand brakes installed on the handle bars at the front of the device. The device is steered by way of crossed steering bars pivoted to each of the rear axle brace, front axle brace, and steering handle. The steering bars are connected diagonally to opposite positions on the front and rear axles such that the axle braces are pivoted in opposite directions as the steering handle is moved—this minimizes turning radius. Springs return the steering handle to a neutral, centered position when there is no pressure on the steering handle. The hand brakes act on the front wheels. This device does not have any sort of tow hook for pulling the sled to a starting position. There is no restraining device or harness on this, or any of the previously described sleds. There is also no “roll-bar” or any sort of plate or device to prevent injury or to keep the sled from tipping over.

U.S. Pat. No. Des. 331,031 to Janoff discloses a design for a land sled. Design patents cover only the look of the device depicted in the Figures and no real description of the device is included in a design patent. This particular land sled differs from the two previously described devices in several ways. It has two large roller type wheels, instead of four smaller wheels. It is capable of being steered by either the hands or feet and can be ridden sitting in an upright position (steering with the feet) or in a prone position (steering with the hands). The steering appears to be accomplished in a way similar to that of known “flexible flyer” type snow sleds—by pushing and/or pulling the large handle bar extending across the front of the device. There are also slots along the side of the sled, towards the back, for gripping when using the sled from a seated position. There does not appear to be any sort of incline to the main body of the sled, on which one would sit or lay prone, although it is difficult to determine much about the mechanics of a device from a design patent.

U.S. Pat. No. 5,354,081 to Huffman et. al. discloses a stunt-riding toy for use on a variety of surfaces including snow. The device may be fitted with four wheels, or skis. This vehicle has a seat and also must be operated from a sitting position, with the feet placed on plates near the front of the device. The device is quite narrow and is steered mainly by leaning in the direction it is desired to turn. The front foot plates also serve as a brake and a means to keep the vehicle from leaning too far and tipping over. If the vehicle leans too far, the plates will contact the ground surface, apply braking pressure and prevent further tipping. The device has two handles and a rear hand cable brake which pulls a plate into contact with the wheels when the hand brake is engaged. The handles are positioned near the rear of the device, close to the seat so that the rider's arms hang down along the rider's side to grip the handles, and keep the rider in an upright position.

The Invention has the particular objectives, features and advantages of: 1) a steerable gravity driven vehicle; 2) that such vehicle is ridden in a prone, face down and face forward position; 3) that such vehicle has at least one brake; 4) that such vehicle has a plurality of wheels, most preferably four (4) wheels however the sled having three (3) wheels—the single wheel preferably located between the legs of the driver—is also disclosed and is within the scope of the disclosure of the invention; 5) that such vehicle may alternatively have a combination of skis and wheels providing for enhanced performance for use on snow covered terrain; 6) that such vehicle may alternatively have at least one ski forward or in the front position of the vehicle and a slide pan toward the rear portion of the vehicle; 7) that such vehicle may alternatively have at least 3 skis, wherein either one ski is forward or in the front position of the vehicle or toward the rear portion of the vehicle; 8) that such vehicle as described in 1) though 7) above may have incorporated therein the mechanism for suspension of the wheels and/or skis which is configured to provide precise control in turns especially the carving of turns, by the skis, while descending on snow cover; and 9) that such vehicle as described in 1) through 4) above may be retrofitted with components in order to create the vehicle(s) described in 5), 6), 7) and 8) above.

Particularly now disclosed is the invention which most generally relates to means for causing the gravity driven type of vehicle of any of the vehicles above described in 1) through 9) to be non-moving when the vehicle is unoccupied by a rider. It is clear and noted that wherein the means for causing non-movement of unoccupied vehicle is at least one movement-limiting system for causing non-movement of an unoccupied vehicle or combination of any or all movement-limiting systems selected from a group consisting of weight detection of objects occupying the rider riding surface, temperature detection of objects occupying the rider riding surface, electrical current flow detection of level of current flow within at least two skin contact points associated with the rider and an activation control mechanism for activating and deactivating the means for causing the vehicle to be non-moving.

The patents noted herein provide considerable information regarding the developments that have taken place in this field of non-motorized vehicle technology. Clearly the instant invention provides many advantages over the prior art inventions noted above. Again it is noted that none of the prior art meets the objects of the gravity driven vehicle in a manner like that of the instant invention. None of them is as effective and as efficient as the instant Gravity Driven Steerable Vehicle for maneuvering down steep, varied surface terrain and none of them are operated from the substantially prone face down and face forward position.

### SUMMARY OF THE INVENTION

The most fundamental objects and advantages of the invention are: 1) a steerable gravity driven vehicle; 2) that such vehicle is ridden in a substantially prone, face down, face forward position; 3) that such vehicle has at least one brake; 4) that such vehicle has at least two wheels or skis/slide pan or a combination thereof; 5) that such vehicle has a steering suspension mechanism which provides for the carving, by the steerable skis, of precise turns on snow covered surfaces, 6) that such vehicle has rear brakes; and 8) a kit of components which are used to retrofit a wheeled vehicle to one with wheels, skis, pan or a combination of wheels, skis or pan.

It should be noted that where there are three (3) wheels on the vehicle, the third wheel may be located either at the front or the rear of the vehicle. The third wheel may be the same size as the other two wheels, or may be large or smaller. The third wheel may be independently steerable, or steerable in cooperation with the steering of the other two wheels.

The vehicle may have independent mechanical, air actuated or hydraulic actuated brakes and may have independent hydraulic shock absorbers on some or all wheels. But the vehicle need not have shock absorbers at all, or may have shock absorption only for the front wheels, for example. The vehicle also may have an attachment for the picking up of the vehicle by, for example, a ski chair lift, and which may be a part of the driver/operator restraint system acting to keep the operator's legs from drifting off of the vehicle especially in a sharp turn maneuver. The attachment for picking up the vehicle may further serve to protect the rider should the vehicle roll over. However, this attachment is not fundamental to the invention.

A primary object of the invention is to provide a gravity driven steerable vehicle comprising a chassis and a riding surface on which a rider is oriented in a prone, face down, face forward position, at least two wheels or skis or combination thereof, means for steering the vehicle, means for causing deceleration or halting of motion of the vehicle, and means for harnessing the rider onto and into the vehicle.

Another primary object of the invention is to provide means for steering each wheel independently.

A further primary object of the invention is to provide means for absorbing shock exerted on said vehicle caused by the vehicle passing over rough terrain.

Another object of the invention is to provide means for towing the vehicle to the top of an incline, and means for assisting the rider in staying on the vehicle and protecting the rider if the vehicle were to roll over.

Yet another object of the invention is to provide such a vehicle further comprising four wheels or skis.

Another object of the invention is to provide such a vehicle having three wheels or skis.

A still further object is to provide a safety brake which actuates upon release of the hand grips for operation and parking safety if a rider were to fall off of the vehicle during operation of the vehicle.

A yet still further object is to provide a means for automatically causing the vehicle to hold a constant turn which actuates upon the occasion if a rider were to fall off of the vehicle during operation of the vehicle.

A fundamental object of this invention is to provide a means or mechanism for suspension of the wheels and/or skis which means or mechanism is comprises a single a-arm pivotably attached to an axle at an axle pivot point and a shock absorber connecting end pivotably connected to one end a shock absorber and which shock absorber other end pivotably connected to said axle. The suspension system may be provided preferably independent for each wheel or ski or on only the front axle of the vehicle. The suspension system configured to provide precise control in turns especially the carving of turns, by the skis, while descending on snow covered terrain.

Another fundamental object of the invention is to provide a ski assembly having front end and a ski rear end, a ski running surface and a ski upward-facing surface and having a ski brake assembly configured to cause, when said brake assembly is operator actuated, a brake blade to extend below said ski running surface at said ski rear end thereby engaging the terrain surface upon which the ski is running. There may also be provided a brake return assembly preferably using springs to return said brake blade to a non-braking position.

Yet another fundamental object of the invention is to provide a means for causing the gravity driven type of vehicle of any of the vehicles above described in 1) through 9) to be non-moving when the vehicle is unoccupied by a rider. It is clear and noted that wherein the means for causing non-movement of unoccupied vehicle is at least one movement-limiting system for causing non-movement of an unoccupied vehicle or combination of any or all movement-limiting systems selected from a group consisting of weight detection of objects occupying the rider riding surface, temperature detection of objects occupying the rider riding surface, electrical current flow detection of level of current flow within at least two skin contact points associated with the rider and an activation control mechanism for activating and deactivating the means for causing the vehicle to be non-moving.

These and further objects of the present invention will become apparent to those skilled in the art after a study of the present disclosure of the invention and with reference to the accompanying drawings which are a part hereof, wherein like numerals refer to like parts throughout, and in which:

### BRIEF DESCRIPTION OF THE SEVERAL VIEWS OF THE DRAWING

FIG. 1 is a combination of a top plan view, a side plan view and a front plan view of the vehicle all of which are illustrating the body curvatures, the rider inclined riding surface/bed and the like;

FIG. 2 shows a top plan view of the vehicle, showing, in shadow the axle, steering, and wheel spindles;

FIG. 3 shows a top plan view of the three (3) wheeled embodiment of the vehicle;

FIG. 4 is a detail view of the assembly axle with an air/oil shock used in the wheel suspension;

FIG. 5 is a detail view of the assembly axle with a coil/oil shock used in the wheel suspension;

FIG. 6 is a detail view of the hydraulic rear wheel brake system;

FIG. 7 is a detail view showing the steering linkage in association with the prone steering position of the rider;

FIG. 8 is a detail view showing the right rear wheel spindle;

FIG. 9 is a detail view showing the right front wheel spindle;

FIG. 10 the two views illustrate detail of the tow-bar assembly which also is a part of the rider restraint system;

FIGS. 11A, 11B and 11C are a top plan view, and side plan view and a rear plan view respectively showing, in shadow, substantially all of the components and their relationship and which illustrates a wheeled vehicle retrofitted with skis on the front and wheels to the rear;

FIGS. 12A, 12B and 12C are a top plan view, and side plan view and a rear plan view respectively showing, in shadow, substantially all of the components and their relationship and which illustrates a wheeled vehicle retrofitted with skis on the front and skis on the rear;

FIGS. 13A, 13B and 13C are a top plan view, and side plan view and a rear plan view respectively showing, in shadow, substantially all of the components and their relationship and which illustrates a wheeled vehicle retrofitted with skis on the front and a slide pan to the rear which slide pan has grooves directed from front to rear which provide lateral stabilizing of the vehicle and which has a suspension system and a piston actuator which actuates braking by pressing the shovel/blade into the snow surface;

FIGS. 14A and 14B is a combined and sectioned drawing of a top plan view and a rear plan view respectively showing, in shadow, substantially all of the components and their relationship and which illustrates a braking system for a vehicle having wheels in the rear;

FIGS. 15A and 15B is a combined and sectioned drawing of a top plan view and a rear plan view respectively showing, in shadow, substantially all of the components and their relationship and which illustrates a braking system for a vehicle having wheels in the front;

FIGS. 16A and 16B is a top plan view and a rear plan view respectively which illustrates in the partial top plan view in shadow the front skis assembled to the front a-arm and also illustrating in shadow the steering linkage, the front brake system and the front suspension system and particularly in FIG. 16B is illustrated the “canting” of the skis;

FIG. 17 is a partial rear plan view of the attachment of a rear ski with brake components and showing, in shadow, the “unloaded” attitude of the ski and the relative positions of the suspension components and the fully loaded shock absorber compressed attitude of the ski and the relative positions of the suspension components;

FIG. 18 is a partial top plan view of the left rear ski attached to the rear axle illustrating the a-arm attachment to the ski post, the a-arm pivot point on the axle, the connection of the a-arm to the shock absorber which is attached to the axle at the shock absorber pivot location and also showing the brake blade, brake arm, brake cylinder;

FIG. 19 is a side plan view of the ski assembly of the invention, which shows, in shadow, the change in position of the brake components of the braking assembly; and

FIG. 19A is a top view of section AA which illustrates the detail of the brake return spring assembly; and

FIG. 20 and FIG. 20A is a combination of perspective views of the vehicle having in one view a rear top angle view of the vehicle with four wheels and in the other view having a front top angle view of the vehicle with four skiis and each particulary illustrating a rider riding surface on the chassis top side configured to cause a rider on said rider riding surface to be oriented in a substantially prone, face down, face forward position wherein the rider riding surface has particular geometric features which provides for a slight elevation in the upper body supporting section, lower positioned and angled thigh to knee region and a slightly elevated—relative to the knee region—ankle and foot support region;

FIG. 21 and FIG. 21A is a combination of a perspective view of the vehicle and a top view showing the rider in position on the vehicle, and the perspective view shows the rider riding surface with a cover removed and displaying a storage region below the chest pressure region of the surface; and

FIG. 22 and FIG. 22A is respectively a top view and a side view of a vehicle having wheels and tires and having a specific system for causing the vehicle to be substantially unaffected with motion from gravity force.

### DETAILED DESCRIPTION OF THE INVENTION

The following is a description of the preferred embodiment of the invention. It is clear that there may be variations in the size and the shape of the gravity driven wheeled vehicle, in the materials used in the construction and in the orientation of the components. Most importantly, the teaching of the wheeled version of the gravity driven vehicle is applicable to the version having skis or pans mounted in place of some or all of the wheels and which is used as a gravity driven vehicle on snow or ice covered downhill terrain. The stability in the absorbing of shock from uneven surface conditions and the stability and performance while making turns while going downhill derives from the combination of the steering and suspension geometry and the inherent shape of the skis mounted in place of the wheels and tires.

A. The Wheeled Gravity Driven Vehicle:

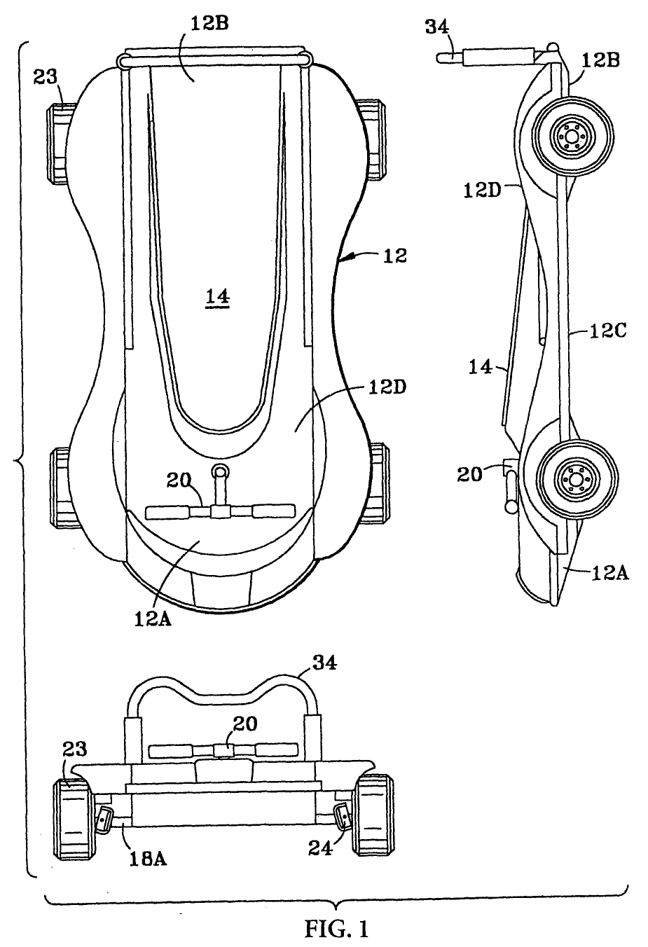

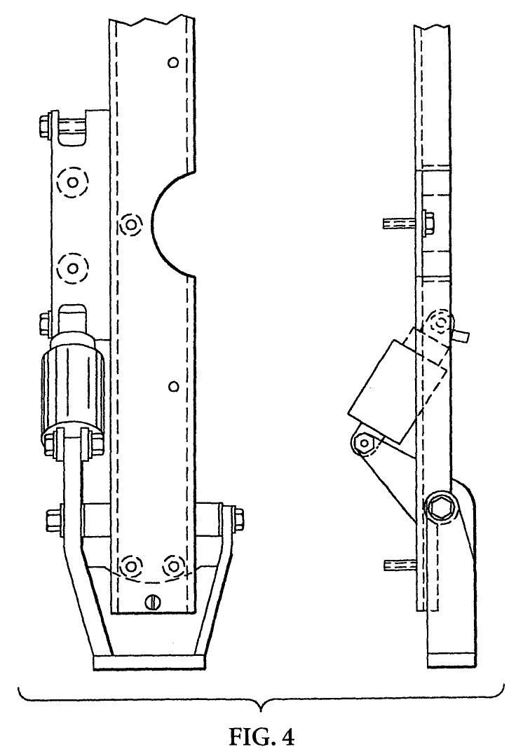

In order to most simply and clearly characterize the essential features of the invention reference is made to drawing FIGS. 1, 1A, 1B, 2, 3, 6 and 10 in which the essential elements of the invention are identified by numerals (not in a circle). FIGS. 4, 5, 7, 8 and 9 are details of various elements which are well known to the ordinary skilled artisan.

It is also important to note that the instant vehicle invention may have one wheel in front and one wheel in the rear. It is also possible to have three wheels with the single wheel either in the front or in the rear of the vehicle. Steering may be effected by using either the front wheel(s) or the rear wheel(s) or both. Braking combinations are likewise possible—front wheel, rear wheel or both.

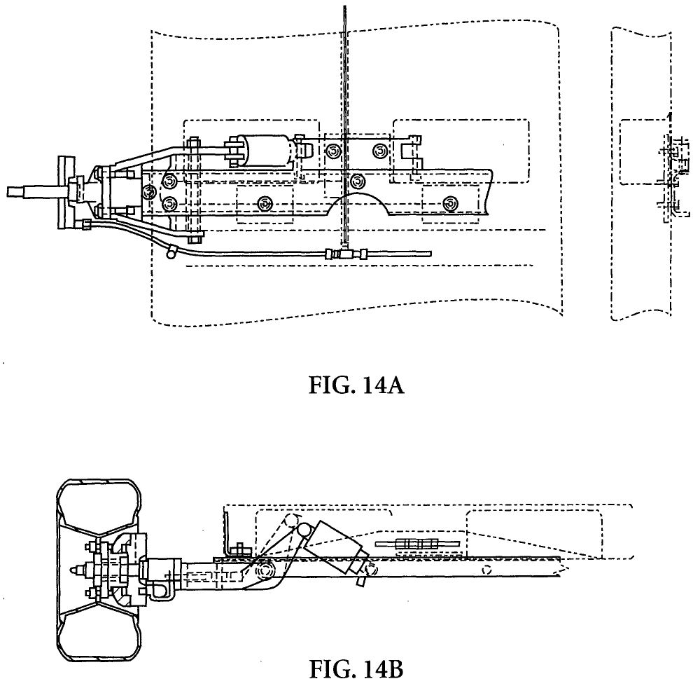

With reference now to particularly FIGS. 1, 2, 3, 6, 10, 14A, 14B, 15A and 15B there is illustrated a four wheeled gravity driven steerable wheeled vehicle 10. There is a chassis 12 having chassis front portion 12A, chassis rear portion 12B, chassis underside 12C and chassis top side 12D. A rider riding surface 14 is on chassis top side 12D and is configured to cause a rider on rider riding surface 14 to be oriented in a prone, face down, face forward position. There is provided a means for attaching, 16, a rear axle assembly 16A substantially at chassis rear portion 12B. There is also means for mounting, 18, a front axle assembly 18A substantially at chassis front portion 12A.

Provided also is a means for steering, 20, gravity driven steerable wheeled vehicle 10 or three-wheeled vehicle 40 by the rider when the rider is positioned on rider riding surface 14. There are rear wheel hub and spindle assemblies 22 integral with rear axle assembly 16A. Wheels and tires 23 are normally mounted to the wheel hub. Front wheel hub and spindle assemblies 24 are integral with front axle assembly 18A.

A braking system or means for causing deceleration and halting of motion 26 of vehicle 10 when vehicle 10 (or 40) has motion is provided. Braking system 26 may be hydraulic, mechanical or a combination of the two and braking may be of all wheels or some of the wheels.

In order to help the rider stay on vehicle 10 or 40, there is a means for harnessing 28 the rider onto and into rider riding surface 14 when the rider is positioned on the vehicle. To provide additional comfort for the rider and to improve the stability of the vehicle while moving, there may be provided means for absorbing shock 20 exerted on each of the front wheels and tires 23 attached to each of the two front wheel hub and spindle assemblies 24 thereby damping shock caused by vehicle 10 passing over rough terrain, between front wheels and tires 23 and front axle assembly 18A. There may also be means for absorbing shock 32 exerted on each of the rear wheels and tires 23 attached to each of the two rear wheel hub and spindle assemblies 22 thereby further damping shock.

In order to get wheeled vehicle 10 or 40 or ski equipped vehicle 10A or 40A up a ski slope for example, there is provided a combination rear roll bar and transport bail 34. When the rider is on the vehicle, bar 34 is in the lowered position providing the rider with a roll bar and an object against which pressure may be applied when the rider is in a sharp turn. Bar 34 is placed in a second position which permits attachment to a lift such as a ski lift.

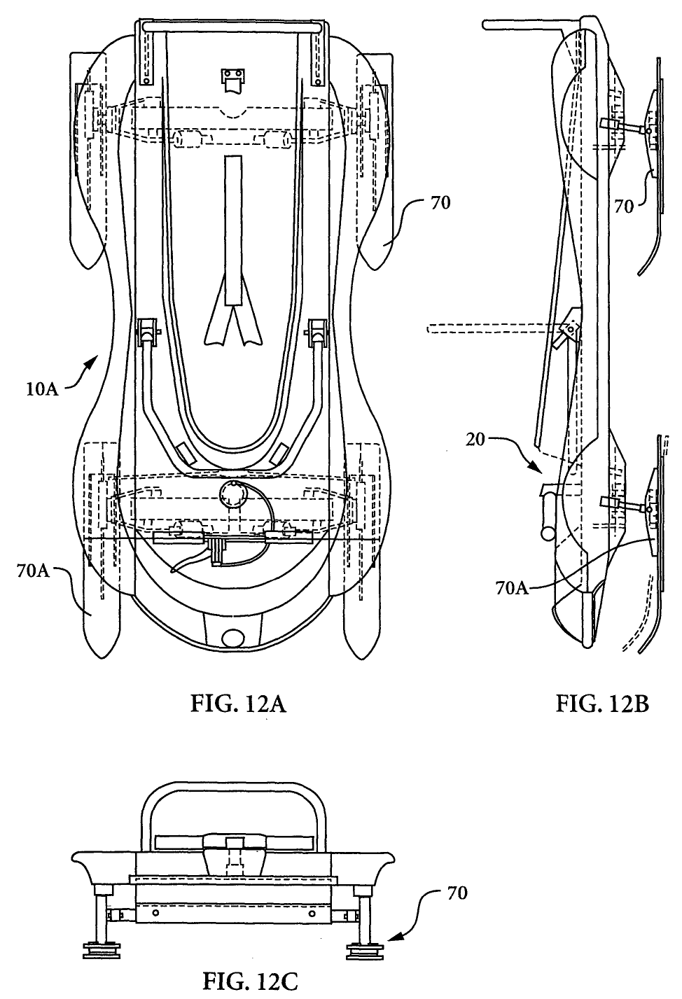

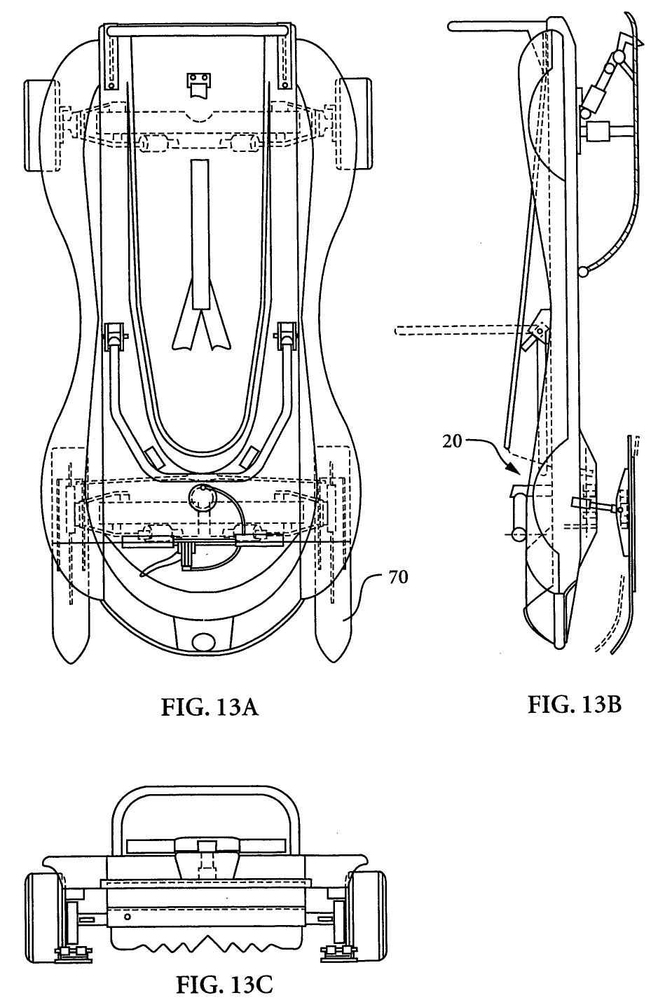

In order to discuss some of the engineering features, reference is again made to the drawings including FIGS. 4-22A. The drawings show simply the preferred embodiments of the wheeled and the ski equipped vehicle which have the following preferred specifications:

FIG. 1 shows a top, side, and front plan view of the vehicle, illustrating the body curvatures, the rider inclined riding surface/bed including the 11″ diameter high speed pneumatic, tubeless tires in the preferred embodiment of the vehicle, which are designed for motor vehicle racing at speeds in excess of 100 mph and which provide excellent traction and a soft but firm ride.

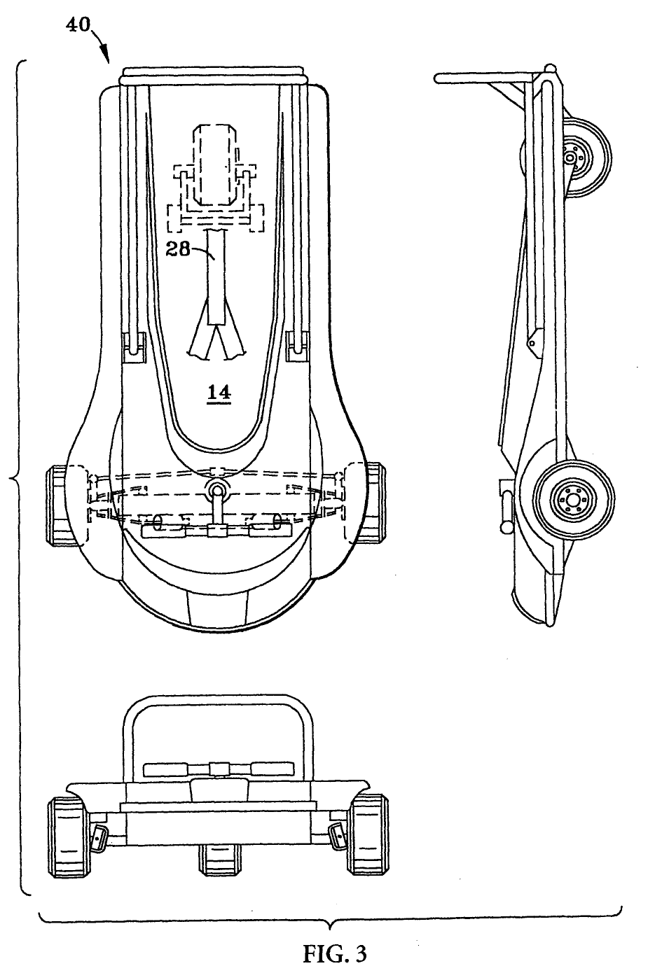

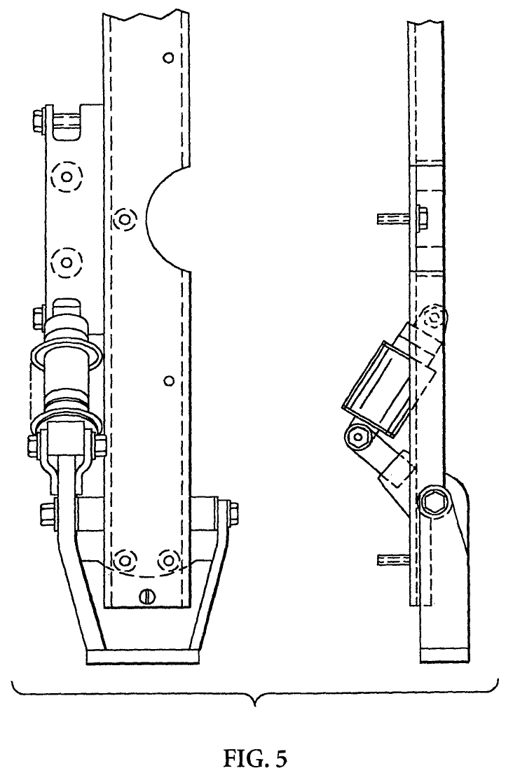

Advanced four wheel “A” arm air spring, oil damped suspension—independent four wheel suspension with air/oil shocks or with coil/oil shocks is provided and yields a smooth, stable ride over surfaces with irregularities ranging from wash board to large bumps. However, not all four wheels need have suspension, possibly only the front wheels might have suspension. Also, the vehicle could be made in either a four-wheeled or three wheeled embodiment. In either embodiment, the suspension is not essential. FIG. 3 illustrates a three (3) wheeled embodiment of the vehicle. FIG. 4 shows a detail view of the assembly axle with an air/oil shock used in the wheel suspension, and FIG. 5 shows a detail view of the assembly axle with a coil/oil shock used in the wheel suspension.

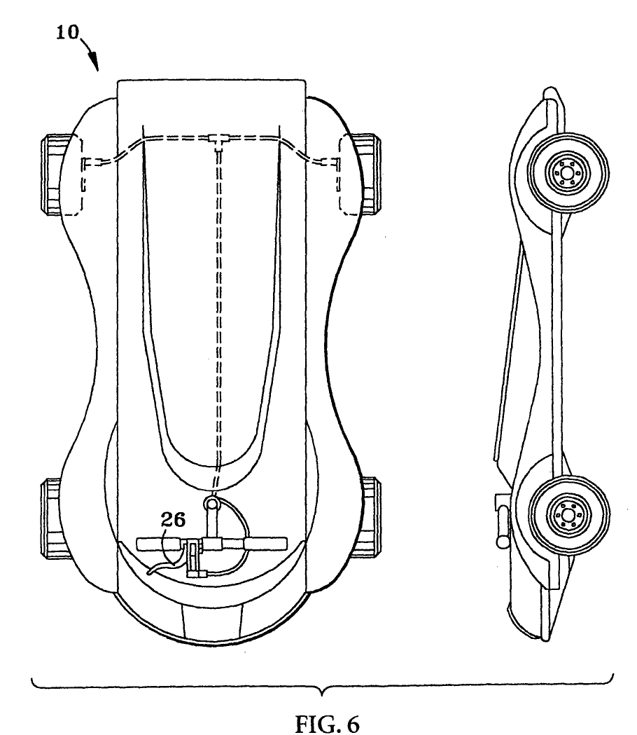

Independent hydraulic braking is provided from dual, real wheel, hydraulic disk brakes, designed for motor vehicle racing at speeds to 150 mph and operated with a single hand lever. These brakes give smooth, uniform and powerful braking capability whether with a four or three-wheeled embodiment. The braking system could be modified for a three-wheeled embodiment. FIG. 6 is a detail view of the hydraulic rear wheel brake system.

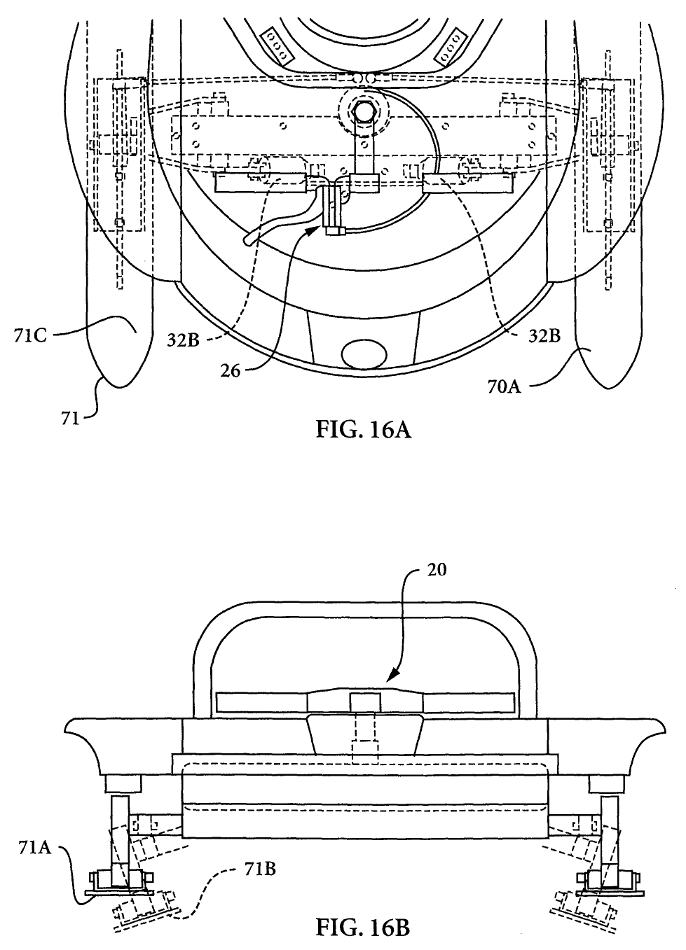

For the detail of the braking system used with the ski equipped version of the vehicles 10A or 40A, reference is made to FIGS. 16-19. Particularly, FIGS. 16A and 16B illustrate in the partial top plan view in shadow front skis 70A assembled to the front a-arm 32A and also illustrating in shadow the steering linkage, the front brake system 80 including brake return system 88 and the front suspension system 30 and particularly in FIG. 16B is illustrated the “canting” of the skis 70A.

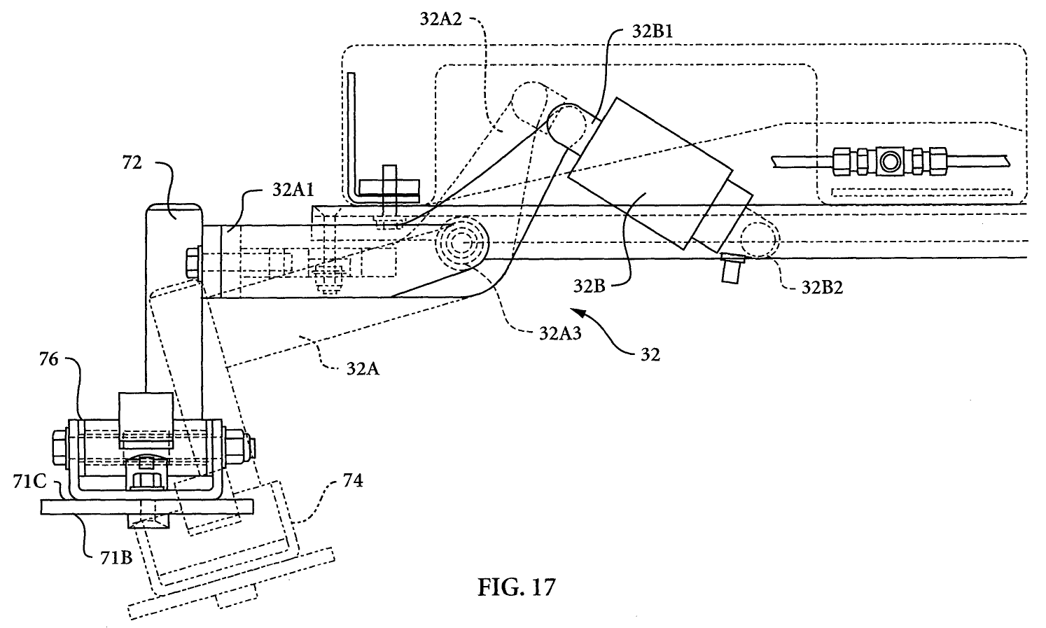

FIG. 17 shows the attachment of a rear ski assembly 70A i.e, the ski assembly having ski brake assembly 80 as a part of ski assembly 70 and also shows, in shadow, the “unloaded” attitude of ski assembly 70A and the relative positions of the suspension components and the fully loaded shock absorber 32B compressed attitude of the ski and the relative positions of the suspension components, i.e., a-arm 32A and the piston of absorber 32B.

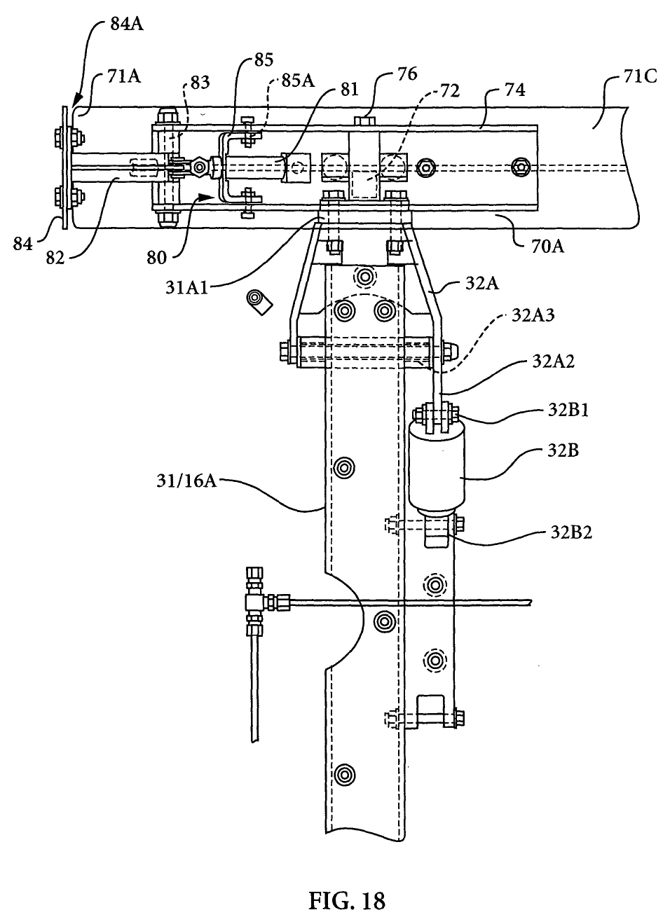

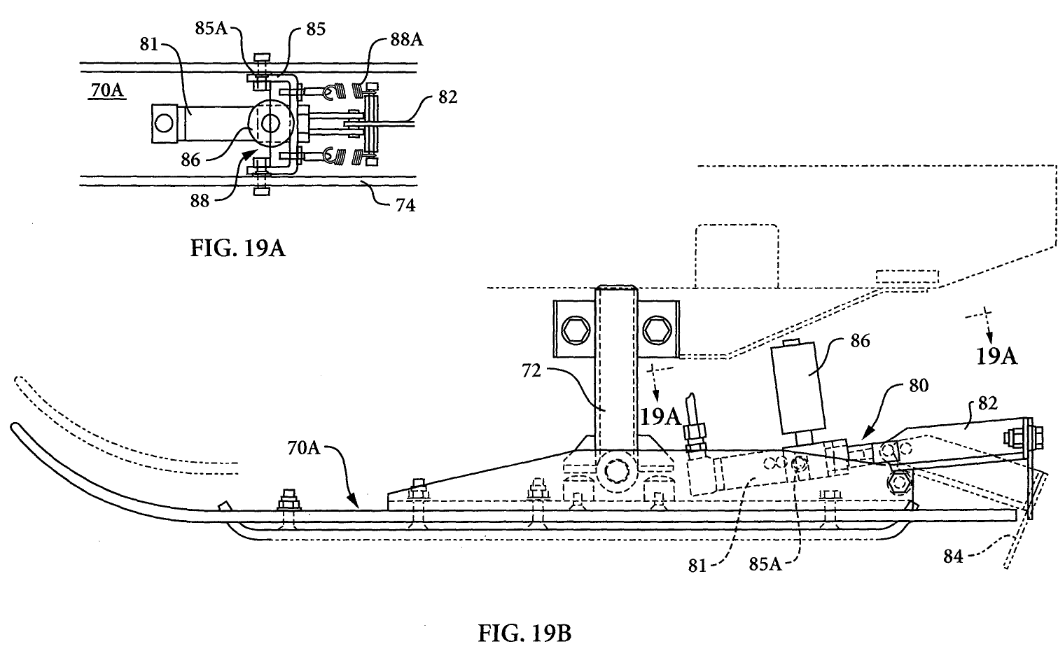

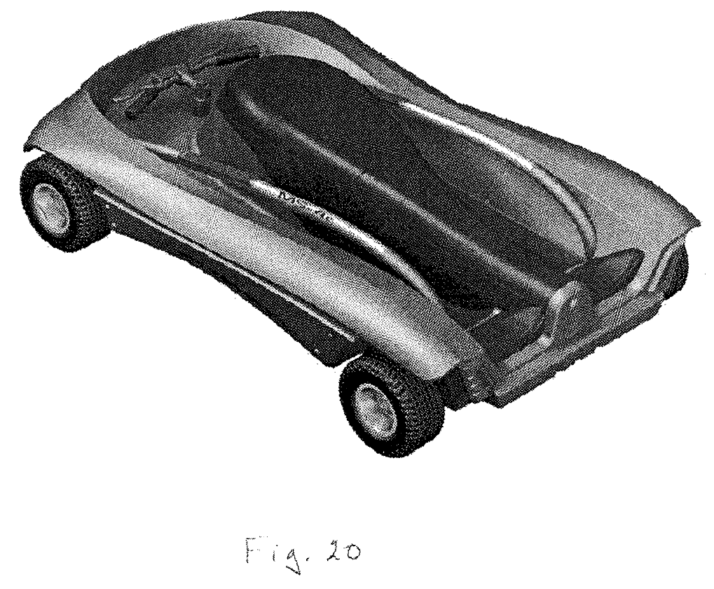

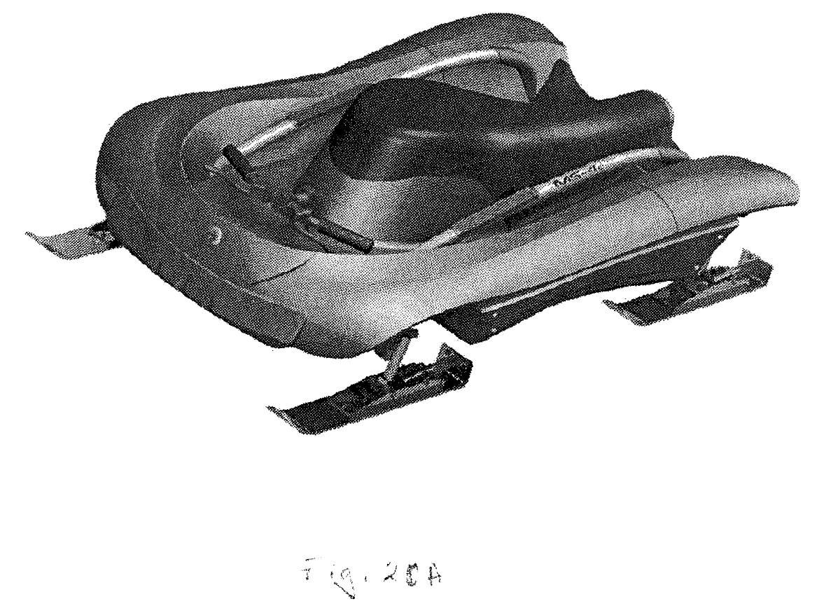

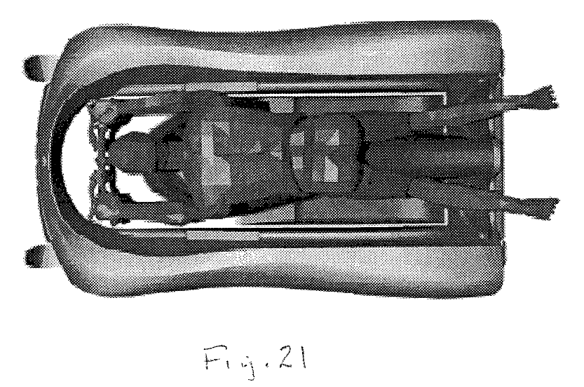

FIG. 18 shows a left rear ski 70A attached to means for absorbing shock 32 which is attached to the rear axle 31, the manner of the a-arm 32A attachment to the ski post 72, the a-arm pivot point 32A3 on the axle 31, the connection of the a-arm shock attachment end 32A2 to the shock absorber end 32B1 which shock absorber is attached to the axle at the shock absorber pivot location 32B2 and also showing the brake blade 84, brake arm 82, and the brake cylinder 81. FIG. 19 is a view of the ski assembly 70A of the invention, which shows, in shadow, the change in position of the brake components of the braking assembly 80. FIG. 19A is a top view of section AA which illustrates the detail of the brake return spring assembly 88 along with return springs 88A.

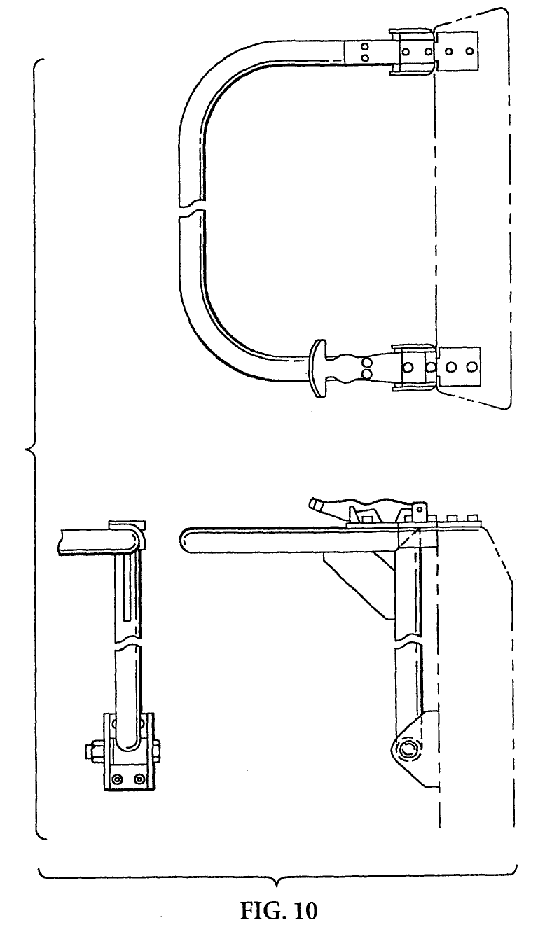

There is provided a combination rear roll bar and transport bail. This bar is hinged so that locked in the folded down position, it tends to confine the legs of the rider and further resists overturning of the vehicle. When this bar is in the unfolded or up position it is useful as a tow or lift bar which may be attachable to a ski lift as an example of use. However, it is possible to have an embodiment of the vehicle without this feature. FIG. 10 illustrates detail of the tow-bar assembly which also is a part of the rider restraint system.

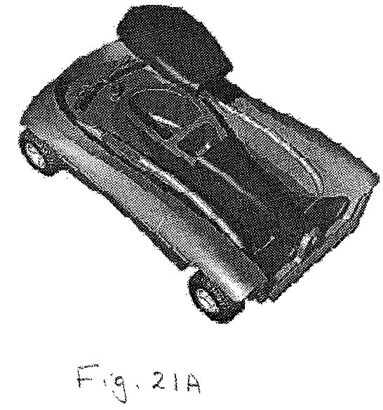

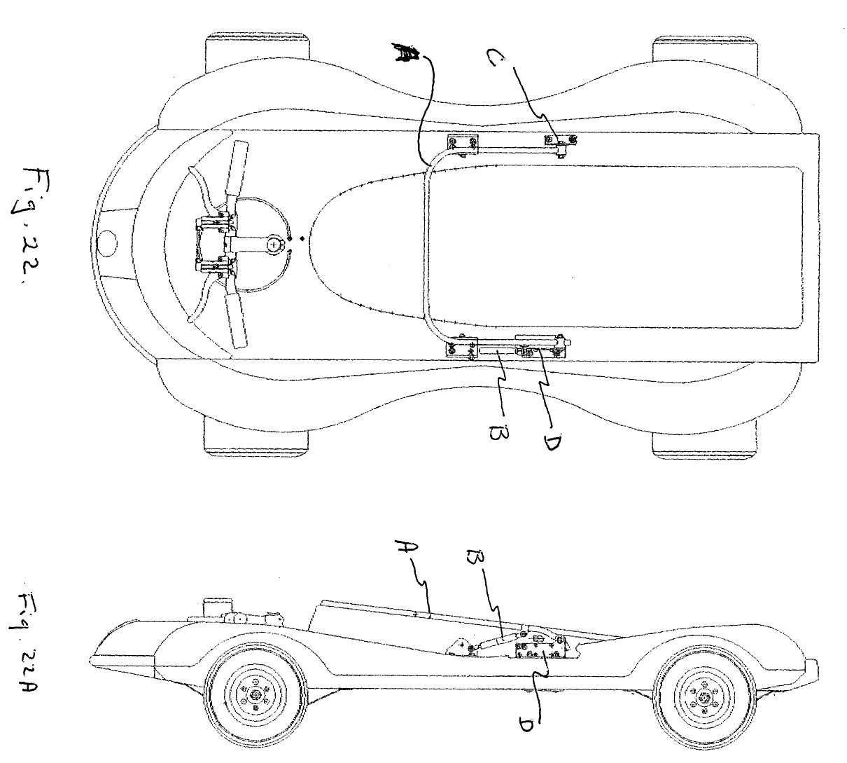

The prone (lying down) low center of gravity design provides control and good visibility. It is also possible that this low position may add to the level of safety for the rider. The extremely low center of gravity provides a relatively stable and safe ride—overturning is nearly impossible. Reference is now made to FIGS. 20 and 20A which simply is a combination of perspective views of the vehicle having in one view a rear top angle view of the vehicle with four wheels and in the other view having a front top angle view of the vehicle with four skiis and each particulary illustrating a rider riding surface on the chassis top side configured to cause a rider on said rider riding surface to be oriented in a substantially prone, face down, face forward position wherein the rider riding surface has particular geometric features which provides for a slight elevation in the upper body supporting section, lower positioned and angled thigh to knee region and a slightly elevated—relative to the knee region—ankle and foot support region. Such design of the rider riding surface adds a level of comfort and safety for the rider using the vehicle. Reference is also made to FIGS. 21 and 21A which illustrate the rider in position and the rider surface with a storage section below the chest portion. Seat/body mount layout provides, at least the following features and advantages: greater visibility, neck angle-less stress, lower back loading reduced, various rider sizes easily accommodated, control-hugging Knee pockets, riding position flexibility and rider size accommodation. Storage Seat/body mount compartments provides for at least: Helmet storage, pull cord Crush zones, low impact energy absorption, replaceable component to protect larger parts from damage. Pontoon deflectors—this stylistic feature prevents interlocking of wheels and acts to prevent, safety Reflectors, front, side and rear Shin cradles provide for cushioning, size adjustability, riding flexibility, control of rider legs, centers leg for greater comfort and a control Side rail assists in mounting, transport, storage, rider cushioning and rider protection from side impact. All of the structural member Design, Ski brake boot covers, shroud and deflectors chute ski shroud and snow deflector Integrated pushbar are all advantageous features of the vehicles of all forms. Further to all of the above information there is also a Rider less Steering return mechanism which incorporates the use of a spring (wound or gas spring) installed on the steering column causing the sled under the spring force to turn and all the way in one direction when the steering bars are not otherwise being guided and therefore in the rider less state of function.

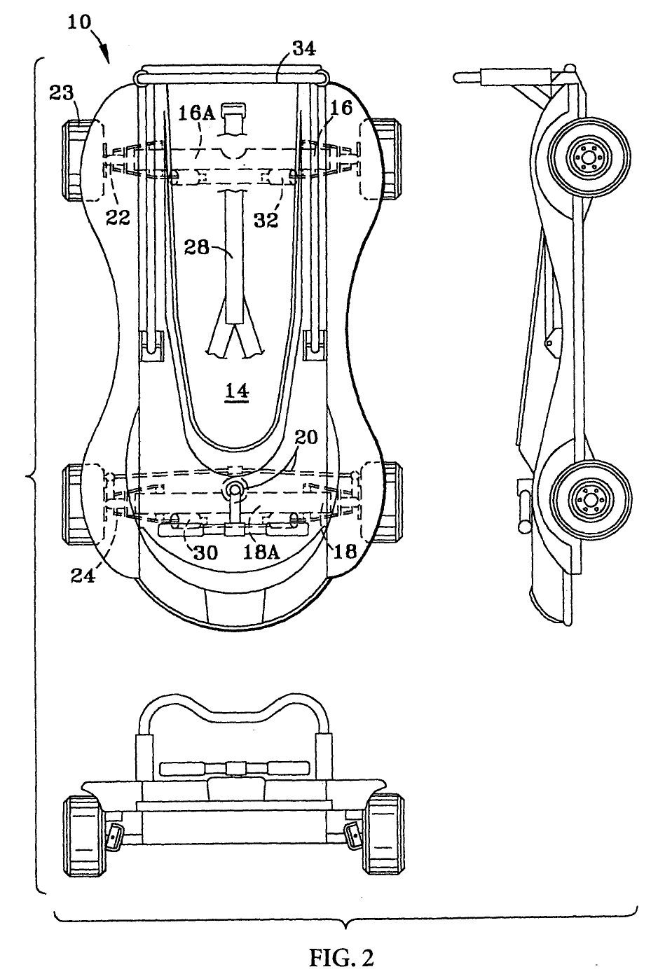

There is provided a safety harness which enhances control, stability and rider safety, and which is shown illustrated in FIGS. 2 and 3. The shoulder harness provides rider stability and contributes to rider safety by keeping the rider in place on the vehicle.

There is also an automatic brake which actuates upon release of the hand grips for operation and parking safety. This feature is not essential to the basic embodiment of the invention, however this is an important additional feature. With this safety braking mechanism, the vehicle will be stopped if the rider were to fall off of the vehicle at some point during the operation of the vehicle. Additional to the automatic brake system there may also be a means for causing the vehicle to go into a constant tight turn mode of operation if the rider loses control or if the rider fall from the vehicle while in motion.

Again, with reference to FIGS. 20, 20A and 21 and 21A and other figures disclosing the rider riding surface or region, the surface of the vehicle on which the rider lays is preferably comprised of a closed cell body pad for rider comfort. There is generally preferred an elevated chest rest and thick foam mat which provide additional rider comfort and visibility.

In the preferred embodiment, the body and chassis of the vehicle is made from light weight foam core fiberglass reinforced construction. The strong, rigid, impact resistant foam filled fiberglass body with aluminum inserts provides a single framework for attachment of all components. Fiberglass body, plated steel parts, and extensive use of aluminum provide optimum protection from the elements, and from impact damage.

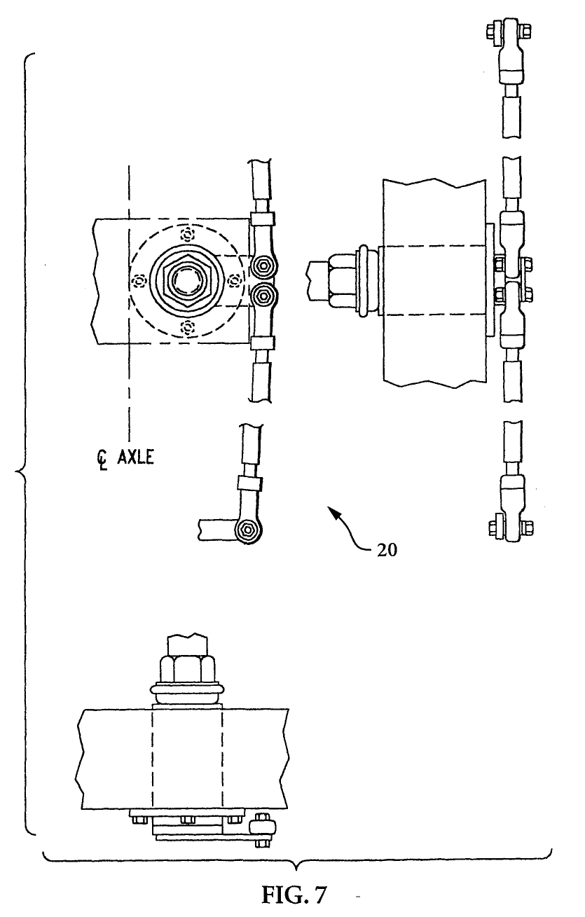

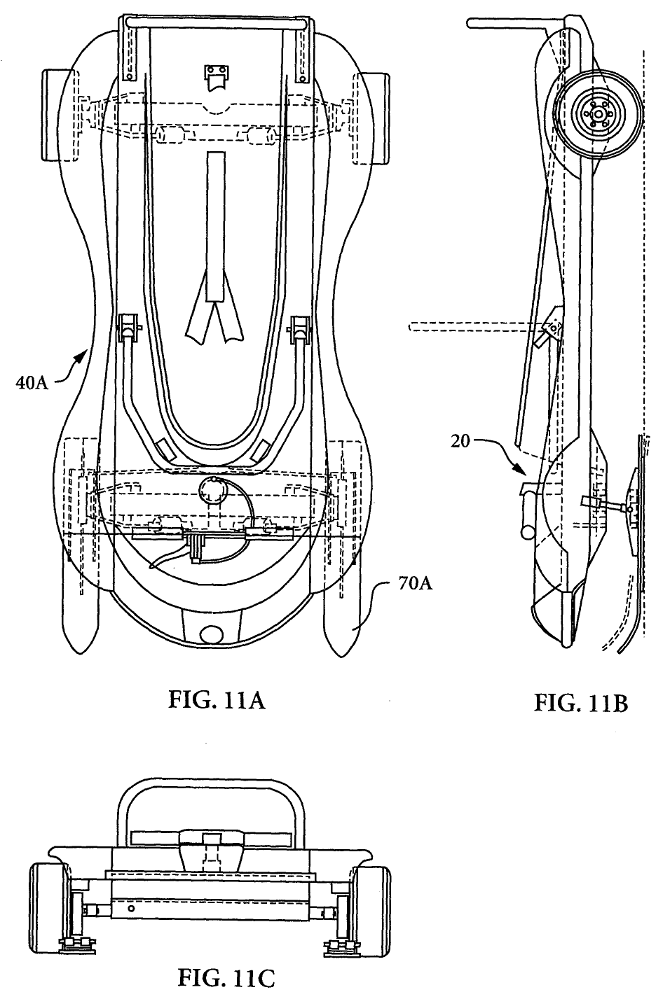

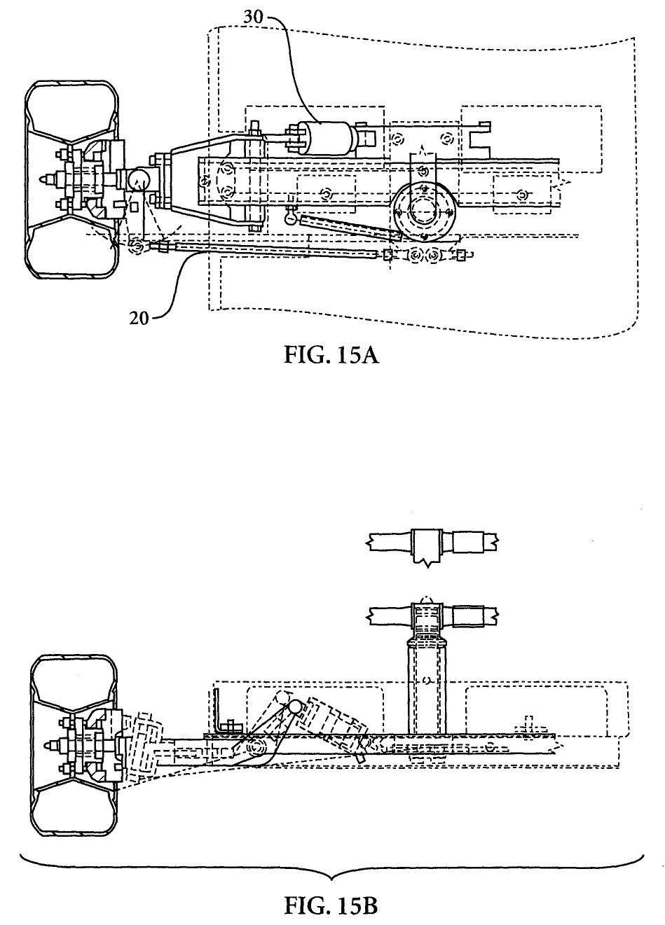

The steering and braking mechanism is a ball bearing bicycle style steering and braking assembly which is positive, responsive and familiar to all to control, thus making learning to ride, and riding the vehicle easier and more comfortable. FIGS. 7 and 15A provide, in combination a detail view showing the prone steering linkage. Substantially the same steering system as shown is FIGS. 7 and 15A is also used in the ski equipped vehicles as shown in FIGS. 11A, 12A, 13A and 16A.

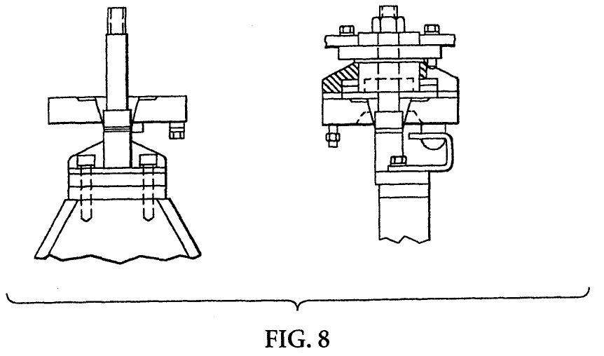

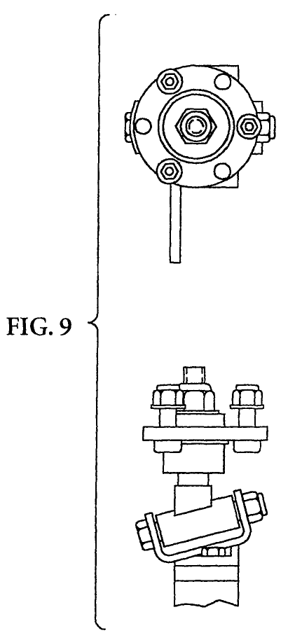

There are provided precision bearings on all four axles in one embodiment. Independent rear axles provide maximum maneuverability in a four wheeled embodiment. The vehicle may be provided with precision wheel hubs, with pre-lubricated ball bearings, which are maintenance free. In a preferred embodiment the suspension and steering spindle bearings are formed of woven TEFLON or NOMEX and are designed to withstand high impact forces and hostile environments, and provide long life with no maintenance. FIG. 2 shows a top, side, and front plan view of the vehicle showing, in shadow, the axle, steering, and wheel spindles. Also, FIGS. 8 and 9 show a detail view showing the right rear wheel spindle and a detail view showing the right front wheel spindle.

The preferred steering post ball bearings and linkage ball rod ends provide maintenance free, smooth, zero back lash response. Each vehicle may be provided with elastomer bumper strips in the front and the rear which provide impact protection for the vehicle and rider. The preferred steering post, wheel, and front and rear axle assemblies can be removed intact should maintenance be required, thus reducing time and cost of any necessary maintenance.

In a preferred embodiment, the vehicle chassis has a ramp-shaped underbody and detachable covers which offer protection for axles, steering linkage, and suspension from road obstacles. Each vehicle in the preferred embodiments has strong, impact resistant fiberglass fenders which protect the rider from track dirt and contact with the wheels or skis when riding.

Following is a general description of the many technical features and the advantages achieved by the presently disclosed invention. It is material provided to further enhance the level of disclosure and present all of the presently known advantages achieved because of the technical features of the invention.

B. The Gravity Driven Vehicle with Skis or Combination of Skis and Wheels or Slide Pan

While much of the following description is presented as a description of a wheeled vehicle similar to the vehicle of the present invention as described above but which has been retrofitted or specially constructed to result in the vehicle for use on snow covered terrain. It is important to note that the vehicle basically as described above but modified for use on snow may be custom made rather than created from a wheeled version by means for retrofitting the wheeled version. All of the disclosure above is applicable to the disclosure of the ski version of the vehicle except of course that portion which relates to the specifics of the braking system and some aspects of the steering systems.

1. Retro Fit Kits/Ski Version

The retrofit kit is used in conjunction with the gravity driven wheeled vehicle of the present invention or other like products to make the product easily adaptable for use in snow covered conditions. The details of the systems described below apply as a retrofit package or basically describe the components and the function when applied to a gravity driven vehicle custom designed and dedicated for use only on snow. I.e., a wheeled vehicle may be retrofitted with the combination of skis or slide pans or custom designed and built in the same manner. FIGS. 11-13 and 16 illustrate the vehicle with skis in the front and wheels to the rear, skis both front and rear, and skis in front and a slide pan with braking to the rear respectively. It should further be noted that the use of skis and slide pan or slide pans is interchangeable in that they both provide the sliding surface upon which the vehicle rides when in descent on a snow covered surface. A slide pan or ski may be used in any combination in the front in the rear or both front and rear locations of the vehicle.

Referring now to FIGS. 11-13 and 16, the front steering system of the present invention is shown. A unique discovery during the course of the development efforts to create the winter or snow covered terrain version of the gravity driven vehicle occurred in the integration of the skis onto the existing single swing arm suspension design of the wheeled product. As a consequence of the advanced four wheel “A” arm air spring, oil damped suspension—independent four wheel suspension with air/oil shocks or with coil/oil shocks as illustrated in at least FIGS. 4, 5, and the multiple views of FIGS. 11-16 there achieved a smooth, stable ride over surfaces with irregularities ranging from wash board to large bumps. With the mounting of skiis to the A-arm or the wishbone portion of the suspension system, the position or attitude of the outer edge of all skis due to the single arm geometry when there is no rider on the sled and the shocks are operating properly, causes the outer edge of all skis to be constantly engaged with the ground or snow surface. When the sled is being ridden the loading of the shocks, depending on how they are set, causes the skis to change to a more flat or level attitude relative to the snow or to the ground surface. This attitude only reaches a substantially flat attitude if there is extreme loading on the sled body and does so to absorb shock to the sled and rider. After such levels of loading and impulse types of shocks to the sled, the sled always returns to the outer edge engagement posture. Substantially because of this characteristic of ski attitude or the inward canting of the skis when the sled is being ridden, on a modest downhill terrain put in particular when travelling on steeper downhill and upon initiation of turns, the lower or downhill ski becomes more heavily loaded tending to increase the flatness orientation relative to the snow surface yet still resulting in the outer edge carving into the snow, i.e., the outer edge of the ski carves into the snow and as it becomes increasingly loaded the suspension slightly counters the digging or carving action but continues to engage the snow surface. The upper ski or uphill ski, particularly the outer edge, with the lesser loading while in the turn it is still partially canted inwardly, carves as well and even more aggressively because of this canted attitude of the uphill ski in the turn. Alternatively described, the uphill ski acts somewhat as an anchor as this engagement becomes more unloaded in an aggressive turn, the a-arm extends its full travel maintains constant engagement with the snow due to the fact the lower or downhill ski is flattening allowing the attitude of the uphill ski to remain in constant contact with the snow. This unexpected performance characteristic or functionality provides benefits such as for example: the carving action of both skis constantly counterbalancing each other provides tremendous control and maneuverability in virtually every snow condition; andunder conditions of heavy loading of the downhill ski, the digging and tipping tendency of the sled is reduced dramatically. To provide further control and maneuverability a keel component may be added to the ski bottoms.

The front ski retrofit is attached to the existing front a-arm (wishbone) assembly of the wheeled version with either a double or the single arm/linkage geometry by utilizing the existing fastening system. When fixed to the suspension linkage the ski has the ability to pivot from an axis perpendicular to the axle allowing the tip and heal to pivot in opposition to one another, upwards and downwards and is limited in its pivot by a stop mechanisms mounted to either the ski or the mounting system. The width and length of the selected skis and the forward or rearward positioning of the pivot point is established based upon the terrain and the specific performance requirements desired. The steering geometry has been designed to create a carving action when the skis are turned by the steering linkage. I.e., upon causing a turn using the steering mechanism both ski tips rise slightly, the tails sink slightly and the inner edge of the ski opposite of the direction of the turn and the outer edge of the ski in the direction of the turn tilt slightly downwards into the snow or ice surfaces. These edges can also be described as the ski edges on the inner radius of the turn.

Referring now to FIGS. 13, 16-19, the independently or simultaneously actuated right and left, rear, front or rear and front, or independent rear and front combined brakes or single brake actuation unit whether one or divided mechanism is integrated in to the front ski and trailing or sliding pan or ski assemblies that are part of the vehicle/mountain sled retrofit package. The actuation of the mountain sled brake is either mechanical, hydraulic, servo-mechanical, pneumatic or a combination of these technologies. When this solution is used as a retrofit it is intended, whenever and wherever possible, that the existing actuation system or systems be utilized.

Referring now to FIG. 13, the rear tracking and control system is shown. The rear brake system or systems is/are integrated into an under body pan covering a portion or all of the sled under body from approximately the middle of the sled length and some distance forward of the rear axle location mounting surfaces and is attached or nearly meets the sled underside and extends sufficiently across the width of the sled in the front in a fixed or in a limited manner with a hinge or slide like interface allowing the pan from the hinge point rearwards to move up and down or to slide or flatten out across the under face of the sled a distance equal to the translated stroke distance of an internally mounted shock system. The pan will be a complete cover with a downward sloping straight or radiused lead edge, running from the mounted or hinged or meeting leading edge and transitioning to a gliding surface that runs almost parallel to the underside of the body or sled frame. The rear pan or ski assemblies will be covering a single or double shock absorption mechanism able to operate independent of or together with each other and the braking mechanism that will be substantially a swing arm or linearly actuated arm or blade that will when actuated protrude out from the pan or ski below their running surfaces and into the snow or ice surface at a positive, negative or right angle to the pan or running surface and will be depth adjustable equal to the geometry and stroke of the actuation. This pan or ski (if chosen) as seen from behind is profiled to provide maximum lateral grip and stability when either turning or gliding. The geometries are optimized to address snow condition and terrain.

The winter retrofit package allows an owner of a summer mountain sled the simplified and flexible solution of utilizing at a minimum a sled body with an integral frame or a sled body with a separate frame. Additionally, depending upon the components of the winter retrofit package, many more of the basic of summer mountain sled components can be used in retrofitting the summer sled for winter recreation such as the axle, suspension, steering and braking systems.

The retrofitted summer sled steering, braking, and rear tracking and control systems provide in the sled retrofitted for winter use all of the already known benefits of summer/wheeled sled including superior control and stability for a snow sledding experience.

2. Alternative Ski Version—Studded Tires

The condition of downhill ice packed or ice covered roadways, trails, paths, etc. presents a braking, steering and control challenge for both a conventional summer mountain sled and a winter mountain sled of any form or configuration. The operational challenge is to provide a sled with a steering and braking solution that handles these conditions. The following embodiment of the invention and declared benefits address this challenge.

A mountain sled equipped with four wheel or three wheel independent or simultaneous braking systems will have its standard tires replaced with slick or profiled tires that have been retrofitted or produced to order with studs, nails, screws, etc. fixed to, inserted into or imbedded in the rolling surface of the tire and protruding from the rolling face of the tire sufficiently to provide contact and grip in the existing ice or ice packed condition on the running surface. The selection of each tire profile and cleat material, cleat geometry and cleat placement and number of cleats is dependent solely on the application surface and can be changed and optimized accordingly to best suit the exact requirements of each downhill surface.

The studded tire solution has the distinct benefit of providing exceptional control on most every downhill ice covered or ice packed roadway, trail, path, etc. running surface. Due to the fact that only the tires used for summer sport are replaced with tires having studs or nails (or the like) mounted to the tread portion of the tire to provide improved friction interface between the sled and the running surface. All other subsystems, steering, suspension and braking remain the same for the studded tire version as for the summer tire version. The resulting sled has substantially all of the performance advantages of the summer wheeled vehicle.

The double arm independent suspension (upper and lower control arm design) has the following advantages. The challenge of providing superior handling and control of a gravity driven mountain sled is to offer the best technology to achieve differing optimized operating results to meet the demands of the conditions and requirements of various terrains. The integration of certain solutions in a mountain sled with tires or with winter attachments such as in various presented solutions is primarily possible due to the combination of certain existing technologies, materials and compact componentry and by integrating them into various suspension geometries. The advent of small components coming from the mountain bike industry, has permitted mountain sledding to move from being basically unsophisticated toys to sophisticated sports equipment.

Integrated into the mountain sled is a suspension system that displays when viewed from the side (from sled rear to front or front to rear) a suspension geometry that is trapezoidal in form (parallelogram) with all four joints forming pivots and the two sled side, upper and lower fastening points/pivots are fixed in some manner firmly to the sled frame or uni-body or axle system or combination thereof and the spindle or the ski assembly or ski pan assembly is fixed somewhere on the fixed member connecting the outboard pivot points of the trapezoid. As part of this design and resisting loading of the trapezoidal design is an arm that extends at an angle away from one of the inboard trapezoid pivot locations and is an integral mechanical arm to which a shock absorber is attached to the end of arm and to a fixed point on the body, frame or axle system and both ends of the shock absorber can pivot. This geometry allows the upright mounting face for the spindle or ski or pan to move the spindle or ski or snow pan assembly upward and downward when the sled is pointed straight forward and when the sled itself has certain load exerted and released such that the tire, ski or pan maintains complete contact of its lower running surface with the operating surface, the running surface remains parallel with itself as it is loaded and unloaded. The longitudinal motion of the entire assembly is limited by the stroke of the shock absorber and the operating envelope of the related mechanics. This design permits minimal axial motion of the contact running surface as it is loaded and unloaded called scrubbing. This scrubbing action is considerably less than that witnessed by the solution already presented in the claim from TSI with a single arm solution.

This solution gives the clear benefits of (1) maintaining constant and maximum contact of the entire running face of the tire, ski, and pan solutions with the running surface, (2) reducing scrubbing and non-uniform wear of the running surfaces of the tires, skis and pans, and (3) simplifying steering geometry compound angles allowing maximization of ski contact and carving benefits. This system is highly recommended for applications utilizing skis and sliding pan systems.

The integrated body and frame design and construction for the instant vehicle represents the latest form of taking the idea of monocoque or body integral frames and eliminating the need for conventional frames and separate bodies for use in mountain sled, sleds and sled product applications. This idea utilizes the fiberglass upper and lower body components known as or halves and sandwiches them together and imbeds inserts to add strength, to bond the halves, to stiffen the body and to take maximum advantage of the collective strength of each system. This solution accommodates and allows the fiberglass to be a connecting structure through the use of adhesives and epoxies that are part of the normal fiber-glassing process of dissimilar materials. This permits the combination of a variety of materials that would not otherwise be combined in a conventional fame/body construction. The imbedded materials then are optimized for their ability to retain fasteners, to choose material that accommodates extreme variations in temperature, adequately spread load across the fiberglass surface and eliminating extra material where it is unnecessary.

The benefits of the integrated body and frame design are (1) provides singular body and frame system, simplifying assembly, inventory and repair, (2) makes maximum use of the strength and stiffness of each system, and (3) allows adaptability and design modifications when new materials come available without requiring the whole design be changed.

There are additional subsystems which may be incorporated into the gravity driven vehicle of each of the embodiments described such as for example: rollover protection, steering damping, accessories such as headlights, speedometer, adjustable steering ratios, prone sled body angle support system, and complete braking system i.e., one system for the front and one for the rear which may use two independent master cylinders and brake circuits.

With respect to the suspension system, the ski assembly and the braking system, suspension geometry action and performance contribute to tracking and steering control. The existing, previously disclosed single A-arm suspension geometry provides the ability to present the outer edge of four skis, when mounted to a two opposing arm axle assemblies, to the snow at an angle to the running surface which delivers significant unique, maneuvering and steering control performance in most all snow conditions. This performance results from the fact that a carving geometry of the skis to the snow occurs. This engagement with the running surface is equally as consistent improves as the sled is underway and is caused to turn through the steering linkage. In a turn or as one is traversing a downhill slope the outboard or downhill ski receives increased load and the ski engages more with the snow/ice running surface until such time that the load on this ski begins to overcome the resisting force of the shock attached to the shock anchor point on the A-arm and the axle. As the resisting force(ajustable) is gradually overcome the A-arm begins to pivot at the A-arm pivot and ski assembly begins to move toward a flatter orientation with the snow. This action helps to avoid over powering the engagement of the downhill ski downhill edge and helping to avoid overturning.

Simultaneously, the uphill ski is less loaded but still has its outer edge engaged in the snow and creates a scrapping action on the adjacent downhill snow/ice as well as packing what ever loose snow is present under the underside of the ski. This uphill ski performance improves as the downhill ski continues to flatten in respect to the running surface and loading. Additionally, the underside of any and all skis can be equipped with various geometry keels to assist in linear or turn tracking of all skis as they, under suspension applied compressive loads, present more ski surface and the keels to the running surface. There are always limits to this performance resulting from excessive speed and surface conditions, etc.

The Ski foot and post pivot allows any ski when traveling over uneven surfaces to follow the terrain contour more closely. The swing motion allowed by this feature is limited by the presence of bumpers mounted on the ski foot which contact ski post extensions when pivot travel limits are reached. This function delivers another benefit because of the ability to allow the ski to follow the terrain more closely that being it causes the brake mounted on the attached ski assembly to achieve more consistent contact with running surface.

The illustrative embodiment brake assembly developed by the applicants provides superior braking action in various snow and ice conditions. The brake assembly has a hydraulic piston actuated lever equipped with a brake blade. This brake is actuated through the introduction of hydraulic pressure into the input port, the pressure causes the piston shaft to extend from the cylinder in the direction of the rear of the ski, the shaft is attached to the brake lever which begins to pivot at the brake lever pivot and rotates the lever with the attached blade toward the running surface until such point that the full stroke piston and the lever has been reached. The developed solution looked to achieve maximum force, with limited space by using a short stroke cylinder and applying multiple ratio motion at the brake tip. Currently, the solution developed provides practically two inches of travel at the brake tip. The solution utilizes external extension springs to assist the brake return when no longer under hydraulic pressure. The solution is further supported by the presence of an expansion tank mounted to and on the non-pressure side of the brake actuation cylinder. The expansion cylinder is partially filled with the same fluid used to actuate the piston and then securely plugged. This expansion tank provides three benefits, closed system that does not allow air to enter the non-pressurized side of the system and contaminate the pressurized side of the system if air were to get by the piston seals, this non-pressurized side of the system could be used to introduce opposing pressure by filling it with more fluid and when compared with an open ended system where an air vent is present to relieve pressure this solution eliminates the likelihood of drawing contaminants such as water into the cylinder or by the piston seals into the pressurized fluid side of the system.

An alternative embodiment brake action and performance assembly developed by the applicants provides superior braking action in various snow and ice conditions. The brake assembly depicted in FIGS. 22 and 22A shows a hydraulic piston actuated lever equipped with a brake blade. This brake is actuated through the introduction of hydraulic pressure into the input port, the pressure causes the piston shaft to retract extend from the fully extended position away from the rear end of the ski, the shaft is attached to the brake lever which begins to pivot at the brake lever pivot and rotates the lever with the attached blade upwards away from and out of the running surface until such point that the full stroke piston and the lever has been fully retracted. The developed solution looked to achieve maximum force, with limited space by using a short stroke cylinder and applying multiple ratio motion at the brake tip. Currently, the solution developed provides practically two inches of travel at the brake tip. The solution utilizes external extension springs to assist the brake return when no longer under hydraulic pressure. The solution is further supported by the presence of an expansion tank mounted to and on the non-pressure side of the brake actuation cylinder. The expansion cylinder is partially filled with the same fluid used to actuate the piston and then securely plugged. This expansion tank provides three benefits, closed system that does not allow air to enter the non-pressurized side of the system and contaminate the pressurized side of the system if air were to get by the piston seals, this non-pressurized side of the system could be used to introduce opposing pressure by filling it with more fluid and when compared with an open ended system where an air vent is present to relieve pressure this solution eliminates the likelihood of drawing contaminants such as water into the cylinder or by the piston seals into the pressurized fluid side of the system.

The gap between the rear end of the ski and the brake blade is critical. The development of this ski brake determined that when braking, the disturbed running surface, snow, ice, etc. needs to find a place to release the braking loads and if this release location is readily available between the blade and the ski it will escape at that point, evidenced through the plume, rooster tail that gets larger the larger the gap and the higher the speed. Conversely, when the gap is reduced to a minimum the loads, forces, energy is then captured under the ski and greatly increases brake drag and brake performance.

New Invention Description

Restricted Movement System for Rider Free Vehicle, and Rider Riding Surface Design:

1. A Restricted Movement System for Rider Free Vehicle

The features of the invention as disclosed and claimed in this application are detailed in the total extent needed by any ordinarily skilled practitioner in fields which relate to the many detail subjects of vehicles generally and also vehicles which have the novel, and unobvious features of the instant specification and the specifications upon which this application relates. It is not a subject of the invention to define exact methods for braking, steering, shock absorbing vehicles which move as a function of gravitational force. The primary subject of this application is to provide, for all the variations of gravity driven vehicles upon which the rider is positioned in a substantially horizontal position with the face down and the face forward, a system to restrict movement of such a vehicle when the vehicle is not being ridden by a rider in the rider riding surface. Clearly, such system to restrict movement may be comprised of a selected combination of means for causing the gravity driven type of vehicle to be non-moving when the vehicle is unoccupied by a rider. It is clear and noted that wherein the means for causing non-movement of unoccupied vehicle is at least one movement-limiting system for causing non-movement of an unoccupied vehicle or combination of any or all movement-limiting systems selected from a group consisting of weight detection of objects occupying the rider riding surface, temperature detection of objects occupying the rider riding surface, electrical current flow detection of level of current flow within at least two skin contact points associated with the rider and an activation control mechanism for activating and deactivating the means for causing the vehicle to be non-moving. Each of the means identified to be useful separately or in various combinations are well known to mechanically inclined persons. Certainly, achieving the functions as defined in the various means listed can be done in many ways all of which are knowledge of ordinary skilled mechanically inclined people. For example, an activation control mechanism could be an electrical switch which provides for the placement of energy to a clamp mechanism which would be activated upon detection of unacceptable weight measure, and/or unacceptable level of current flow between the two skin contact points, and/or unacceptable temperature range measured by the temperature detecting system etc. Additionally, the activation control mechanism could simply be the manual positioning of a gear which will interact with a clamp when the clamp is activated as a consequence of not obtaining acceptable measurement of any one or any combination of temperature, weight and electrical conductivity. Further, it is clear that the means for measuring temperature, weight and electrical conductivity are numerous and known to all of ordinary skill. Thus, it is not critical or essential that applicants/inventors provide the description of many, many, many ways of achieving the functions as defined as means for detecting and measuring one or all of the elements of weight, temperature and current conduction and consequencial restriction of the motion of the vehicle if such measurements are not within an acceptable range of values. Such things are not subjects of the instant invention but any form of such means when used with the defined vehicles are acceptable and such use and such combinations of use of one, two or all the means for measuring are within the scope of the invention.

FIG. 22 and FIG. 22A is respectively a top view and a side view of a vehicle having wheels and tires and having a specific system for causing the vehicle to be substantially unaffected with motion from gravity force. The system to restrict movement of such a vehicle when the and 21A has means for detecting weight which is below a predetermined amount and a means for directing hydraulic force to a brake system which is also used by a rider applying brake action using levers on the steering grip regions. With a rider in position the—depression bar or also called the pivoted rider bale—, is depress downward and located below the chest region of the rider. This depressed position causing or allows activation of the braking elements by the rider with compression of the braking levers. Without a rider in riding position or with insufficient weight to cause the full depression of the—depression bar—, the consequent location of the—depression bar—provides shut-down of the rider operatable brake levers and causes full braking energy to be applied to the brake components which reduce and/or eliminate movement of the vehicle. Further, see FIGS. 22 and 22A for a specific manner for the solution of the braking/non-movement character of a sled not being ridden. This solution utilizes the pivoted rider bale (A) which straddles the body rest and pivots from anchor points located to either side of the body rest. Secured to the upper deck of the sled and fastened to its own pivot is the bale gas spring (B) whose opposite end is fastened to the forward leaning vertical arm of the rider bale on one side. On the lower side of the bale, on the opposite side of the pivot is a short actuation arm (C). Mounted on the sled deck and forward of the rider bale pivot and the short actuation arm is a rider-less speed reduction system (RSRS) master cylinder (D) with a piston shaft extending to the rear of the sled with the same centerline and face with the rider pivot short actuation arm. The RSRS master cylinder is attached on one end to the hydraulic line from the rider operated master cylinder mounted on the handlebar of the sled and attached to a hydraulic line on the opposite end which lead to the (in this case) rear brakes (ski and wheel). When the rider bale is in the upright position, the bale gas spring is fully extended, the rider pivot short actuation arm is fully engaged with the RSRS master cylinder piston causing it to close off the hydraulic line to the rider operated master cylinder and actuates the rear brakes to the full extent of their stroke. This operating state is the rider-less operating condition. When the rider bale is depressed onto the rider chest/body rest as when rider is lying on the rest and the bale gas spring is fully retracted the RSRS master cylinder is fully extended, the RSRS master cylinder allows free flow from the rider operated master cylinder to the rear brakes. This is the sled operating state and permits unrestricted brake operation by the sled rider from the handlebar mounted master cylinder. It is important to note that the braking system may be hydraulic, mechanical or a combination of the two and braking may be of all wheels or some of the wheels. Clearly, such system to restrict movement may be comprised of a selected combination of means for causing the gravity driven type of vehicle to be non-moving when the vehicle is unoccupied by a rider. It is clear and noted that wherein the means for causing non-movement of unoccupied vehicle is at least one movement-limiting system for causing non-movement of an unoccupied vehicle or combination of any or all movement-limiting systems selected from a group consisting of weight detection of objects occupying the rider riding surface, temperature detection of objects occupying the rider riding surface, electrical current flow detection of level of current flow within at least two skin contact points associated with the rider and an activation control mechanism for activating and deactivating the means for causing the vehicle to be non-moving.

2. A Rider Riding Surface Design

Again, with reference to FIGS. 20, 20A, 21 and 21A and other figures disclosing the rider riding surface or region, the surface of the vehicle on which the rider lays is preferably comprised of a closed cell body pad for rider comfort. There is generally preferred an elevated chest rest and thick foam mat which provide additional rider comfort and visibility. The prone (lying down) low center of gravity design provides control and good visibility. It is also possible that this low position may add to the level of safety for the rider. The extremely low center of gravity provides a relatively stable and safe ride—overturning is nearly impossible.

Reference is now again made to FIGS. 20 and 20A which simply is a combination of perspective views of the vehicle having in one view a rear top angle view of the vehicle with four wheels and in the other view having a front top angle view of the vehicle with four skiis and each particulary illustrating a rider riding surface on the chassis top side configured to cause a rider on said rider riding surface to be oriented in a substantially prone, face down, face forward position wherein the rider riding surface has particular geometric features which provides for a slight elevation in the upper body supporting section, lower positioned and angled thigh to knee region and a slightly elevated—relative to the knee region—ankle and foot support region. Such design of the rider riding surface adds a level of comfort and safety for the rider using the vehicle.

Reference is also again made to FIGS. 21 and 21A which illustrate the rider in position and the rider surface with a storage section below the chest portion. Seat/body mount layout provides, at least the following features and advantages: greater visibility, neck angle-less stress, lower back loading reduced, various rider sizes easily accommodated, control-hugging Knee pockets, riding position flexibility and rider size accommodation. Storage Seat/body mount compartments provides for at least: Helmet storage, pull cord Crush zones, low impact energy absorption, replaceable component to protect larger parts from damage. Pontoon deflectors—this stylistic feature prevents interlocking of wheels and acts to prevent, safety Reflectors, front, side and rear Shin cradles provide for cushioning, size adjustability, riding flexibility, control of rider legs, centers leg for greater comfort and a control Side rail assists in mounting, transport, storage, rider cushioning and rider protection from side impact. All of the structural member Design, Ski brake boot covers, shroud and deflectors chute ski shroud and snow deflector Integrated pushbar are all advantageous features of the vehicles of all forms. Further to all of the above information there is also a Rider less Steering return mechanism which incorporates the use of a spring (wound or gas spring) installed on the steering column causing the sled under the spring force to turn and all the way in one direction when the steering bars are not otherwise being guided and therefore in the rider less state of function.

3. General Comments

While additional manners to accomplish the performance of each of the subsystems are not being described in detail herein, it is certainly within the skill of the ordinary artisan in the field of mechanics and mechanical design to understand and implement many types of mechanisms or systems addressing the incorporation of any or all of the above subsystems into any one of the vehicles as described as the instant invention.

It is thought that the present gravity driven steerable vehicle, for use in riding or racing primarily down hill over varied terrain, and many of its attendant advantages is understood from the foregoing description and it will be apparent that various changes may be made in the form, construction and arrangement of the parts thereof without departing from the spirit and scope of the invention or sacrificing all of its material advantages, the form hereinbefore described being merely a preferred or exemplary embodiment thereof.

We claim:

1. A gravity driven steerable wheeled vehicle comprising:
a chassis having a front portion, a rear portion, an underside and a top side;
a rider riding surface on said chassis top side configured to cause a rider on said rider riding surface to be oriented in a substantially prone, face down, face forward position;
means for attaching a rear axle assembly substantially at said chassis rear portion;
means for mounting a front axle assembly substantially at said chassis front portion;
means for steering said gravity driven steerable wheeled vehicle by said rider when said rider is positioned on said rider riding surface;
at least one but not more than two rear wheel hub and spindle assemblies integral with said rear axle assembly;
at least one but not more than two front wheel hub and spindle assemblies integral with said front axle assembly;
means for causing said vehicle to be non-moving when said vehicle is unoccupied by a rider wherein said means for causing non-movement of unoccupied vehicle is at least one movement-limiting system for causing non-movement of an unoccupied vehicle or combination of any or all movement-limiting systems selected from a group consisting of weight detection of objects occupying said rider riding surface, temperature detection of objects occupying said rider riding surface, electrical current flow detection of level of current flow within at least two skin contact points associated with said rider; and
activation control mechanism for activating and deactivating said means for causing said vehicle to be non-moving.

2. The gravity driven steerable wheeled vehicle according to claim 1 further comprising means for causing deceleration and halting of motion of said vehicle when said vehicle has motion and being used by a rider on said rider riding surface.

3. The gravity driven steerable wheeled vehicle according to claim 1 further comprising means for harnessing the rider onto and into said rider riding surface when said rider is positioned on said vehicle.

4. The gravity driven steerable wheeled vehicle according to claim 2 further comprising means for harnessing the rider onto and into said rider riding surface when said rider is positioned on said vehicle.

5. The gravity driven steerable wheeled vehicle according to claim 1 further comprising means for absorbing shock exerted on front wheels and tires attached to said at least one but not more than two front wheel hub and spindle assemblies thereby damping shock, caused by said vehicle passing over rough terrain, between said front wheels and tires and said front axle assembly.

6. The gravity driven steerable wheeled vehicle according to claim 3 further comprising means for absorbing shock exerted on front wheels and tires attached to said at least one but not more than two front wheel hub and spindle assemblies thereby damping shock, caused by said vehicle passing over rough terrain, between said front wheels and tires and said front axle assembly.

7. The gravity driven steerable wheeled vehicle according to claim 4 further comprising means for absorbing shock exerted on front wheels and tires attached to said at least one but not more than two front wheel hub and spindle assemblies thereby damping shock, caused by said vehicle passing over rough terrain, between said front wheels and tires and said front axle assembly.

8. The gravity driven steerable wheeled vehicle according to claim 5 further comprising means for absorbing shock exerted on rear wheels and tires attached to said at least one but not more than two rear wheel hub and spindle assemblies thereby damping shock, caused by said vehicle passing over rough terrain, between said rear wheels and tires and said rear axle assembly.

9. The gravity driven steerable wheeled vehicle according to claim 6 further comprising means for absorbing shock exerted on rear wheels and tires attached to said at least one but not more than two rear wheel hub and spindle assemblies thereby damping shock, caused by said vehicle passing over rough terrain, between said rear wheels and tires and said rear axle assembly.

10. The gravity driven steerable wheeled vehicle according to claim 7 further comprising means for absorbing shock exerted on rear wheels and tires attached to said at least one but not more than two rear wheel hub and spindle assemblies thereby damping shock, caused by said vehicle passing over rough terrain, between said rear wheels and tires and said rear axle assembly.

11. The gravity driven steerable wheeled vehicle according to claim 1 wherein said means steering said gravity driven steerable wheeled vehicle comprises a steering system for steering said front axle assembly.

12. The gravity driven steerable wheeled vehicle according to claim 10 wherein said means steering said gravity driven steerable wheeled vehicle comprises a steering system for steering said front axle assembly.

13. The gravity driven steerable wheeled vehicle according to claim 1 wherein said means steering said gravity driven steerable wheeled vehicle comprises a steering system for steering said rear axle assembly.

14. The gravity driven steerable wheeled vehicle according to claim 10 wherein said means steering said gravity driven steerable wheeled vehicle comprises a steering system for steering said rear axle assembly.

15. The gravity driven steerable wheeled vehicle according to claim 11 wherein said means steering said gravity driven steerable wheeled vehicle further comprises a steering system for steering said rear axle assembly.

16. The gravity driven steerable wheeled vehicle according to claim 12 wherein said means steering said gravity driven steerable wheeled vehicle comprises a steering system for steering said rear axle assembly.

17. The gravity driven steerable wheeled vehicle according to claim 11 wherein said means for causing deceleration and halting of motion of said vehicle is at least one hydraulic brake mechanism braking at least one of said at least one but not more than two front wheel hub and spindle assemblies.

18. The gravity driven steerable wheeled vehicle according to claim 16 wherein said means for causing deceleration and halting of motion of said vehicle is at least one hydraulic brake mechanism braking at least one of said at least one but not more than two front wheel hub and spindle assemblies.

19. A gravity driven steerable wheeled vehicle comprising:
a chassis having a front portion, a rear portion, an underside and a top side;
a rider riding surface on said chassis top side configured to cause a rider on said rider riding surface to be oriented in a prone, face down, face forward position;
means for attaching a rear axle assembly substantially at said chassis rear portion;
means for mounting a front axle assembly substantially at said chassis front portion;
means for steering said gravity driven steerable wheeled vehicle by said rider when said rider is positioned on said rider riding surface;
two rear wheel hub and spindle assemblies integral with said rear axle assembly, one rear wheel hub and spindle assembly at each end of said rear axle assembly; and
two front wheel hub and spindle assemblies integral with said front axle assembly, one front wheel hub and spindle assembly at each end of said front axle assembly;
means for causing said vehicle to be non-moving when said vehicle is unoccupied by a rider wherein said means for causing non-movement of unoccupied vehicle is at least one movement-limiting system for causing non-movement of an unoccupied vehicle or combination of any or all movement-limiting systems selected from a group consisting of weight detection of objects occupying said rider riding surface, temperature detection of objects occupying said rider riding surface, electrical current flow detection of level of current flow within at least two skin contact points associated with said rider; and
activation control mechanism for activating and deactivating said means for causing said vehicle to be non-moving.

20. The gravity driven steerable wheeled vehicle according to claim 19 further comprising means for causing deceleration and halting of motion of said vehicle when said vehicle has motion and being used by a rider on said rider riding surface.

21. The gravity driven steerable wheeled vehicle according to claim 19 further comprising means for harnessing the rider onto and into said rider riding surface when said rider is positioned on said vehicle.

22. The gravity driven steerable wheeled vehicle according to claim 20 further comprising means for harnessing the rider onto and into said rider riding surface when said rider is positioned on said vehicle.

23. The gravity driven steerable wheeled vehicle according to claim 19 further comprising means for absorbing shock exerted on each said front wheels and tires attached to said two front wheel hub and spindle assemblies thereby damping shock, caused by said vehicle passing over rough terrain, between said front wheels and tires and said front axle assembly.

24. The gravity driven steerable wheeled vehicle according to claim 21 further comprising means for absorbing shock exerted on each said front wheels and tires attached to said two front wheel hub and spindle assemblies thereby damping shock, caused by said vehicle passing over rough terrain, between said front wheels and tires and said front axle assembly.

25. The gravity driven steerable wheeled vehicle according to claim 22 further comprising means for absorbing shock exerted on each said front wheels and tires attached to said two front wheel hub and spindle assemblies thereby damping shock, caused by said vehicle passing over rough terrain, between said front wheels and tires and said front axle assembly.

26. The gravity driven steerable wheeled vehicle according to claim 25 further comprising means for absorbing shock exerted on each said rear wheels and tires attached to each said two rear wheel hub and spindle assemblies thereby damping shock caused by said vehicle passing over rough terrain, between said rear wheels and tires and said rear axle assembly.

27. A gravity driven steerable wheeled vehicle comprising:
a chassis having a front portion, a rear portion, an underside and a top side;
a rider riding surface on said chassis top side configured to cause a rider on said rider riding surface to be oriented in a prone, face down, face forward position;
means for attaching a rear axle assembly substantially at said chassis rear portion;
means for mounting a steerable front axle assembly substantially at said chassis front portion;
means for steering said gravity driven steerable wheeled vehicle by said rider when said rider is positioned on said rider riding surface;
two rear Wheel hub and spindle assemblies integral with said rear axle assembly, one rear wheel hub and spindle assembly at each end of said rear axle assembly;
two front wheel hub and spindle assemblies integral with said front axle assembly, one front wheel hub and spindle assembly at each end of said front axle assembly;
means for absorbing shock exerted on each said front wheels and tires attached to each said two front wheel hub and spindle assemblies thereby damping shock caused by said vehicle passing over rough terrain, between said front wheels and tires and said front axle assembly;
means for absorbing shock exerted on each said rear wheels and tires attached to each said two rear wheel hub and spindle assemblies thereby damping shock caused by said vehicle passing over rough terrain, between said rear wheels and tires and said rear axle assembly; and
means for causing deceleration and halting of motion of said vehicle when said vehicle has motion;
means for harnessing the rider onto and into said rider riding surface when said rider is positioned on said vehicle;
means for causing said vehicle to be non-moving when said vehicle is unoccupied by a rider wherein said means for causing non-movement of unoccupied vehicle is at least one movement-limiting system for causing non-movement of an unoccupied vehicle or combination of any or all movement-limiting systems selected from a group consisting of weight detection of objects occupying said rider riding surface, temperature detection of objects occupying said rider riding surface, electrical current flow detection of level of current flow within at least two skin contact points associated with said rider; and
activation control mechanism for activating and deactivating said means for causing said vehicle to be non-moving.

28. A gravity driven steerable vehicle comprising:
a chassis having a front portion, a rear portion, an underside and a top side;
a rider riding surface on said chassis top side configured to cause a rider on said rider riding surface to be oriented in a prone, face down, face forward position;
means for attaching a rear axle assembly substantially at said chassis rear portion;
means for mounting a front axle assembly substantially at said chassis front portion;
means for steering said gravity driven steerable wheeled vehicle by said rider when said rider is positioned on said rider riding surface;
at least one but not more than two rear wheel hub and spindle assemblies integral with said rear axle assembly;
at least one but not more than two front wheel hub and spindle assemblies integral with said front axle assembly;
means for retrofitting said gravity driven steerable wheeled vehicle with at least one ski assembleable to at least one of said at least one but not more than two rear wheel hub and spindle assemblies and said at least one but not more than two front wheel hub and spindle assemblies;
means for causing said vehicle to be non-moving when said vehicle is unoccupied by a rider wherein said means for causing non-movement of unoccupied vehicle is at least one movement-limiting system for causing non-movement of an unoccupied vehicle or combination of any or all movement-limiting systems selected from a group consisting of weight detection of objects occupying said rider riding surface, temperature detection of objects occupying said rider riding surface, electrical current flow detection of level of current flow within at least two skin contact points associated with said rider; and
activation control mechanism for activating and deactivating said means for causing said vehicle to be non-moving.

29. The gravity driven steerable vehicle according to claim 28 further comprising means for causing deceleration and halting of motion of said vehicle when said vehicle has motion and being used by a rider on said rider riding surface.

30. The gravity driven steerable vehicle according to claim 28 further comprising means for harnessing the rider onto and into said rider riding surface when said rider is positioned on said vehicle.

31. The gravity driven steerable vehicle according to claim 29 further comprising means for harnessing the rider onto and into said rider riding surface when said rider is positioned on said vehicle.

32. The gravity driven steerable vehicle according to claim 28 further comprising means for absorbing shock exerted on said at least one ski attached to said at least one but not more than two front wheel hub and spindle assemblies thereby damping shock, caused by said vehicle passing over rough terrain, between said at least one ski and said front axle assembly.

33. The gravity driven steerable vehicle according to claim 30 further comprising means for absorbing shock exerted on said at least one ski attached to said at least one but not more than two front wheel hub and spindle assemblies thereby damping shock, caused by said vehicle passing over rough terrain, between said at least one ski and said front axle assembly.

34. The gravity driven steerable vehicle according to claim 31 further comprising means for absorbing shock exerted on said at least one ski attached to said at least one but not more than two front wheel hub and spindle assemblies thereby damping shock, caused by said vehicle passing over rough terrain, between said at least one ski and said front axle assembly.

35. The gravity driven steerable vehicle according to claim 32 further comprising means for absorbing shock exerted on said at least one ski attached to said at least one but not more than two rear wheel hub and spindle assemblies thereby damping shock, caused by said vehicle passing over rough terrain, between said at least one ski and said rear axle assembly.

36. The gravity driven steerable vehicle according to claim 33 further comprising means for absorbing shock exerted on said at least one ski attached to said at least one but not more than two rear wheel hub and spindle assemblies thereby damping shock, caused by said vehicle passing over rough terrain, between said at least one ski and said rear axle assembly.

37. The gravity driven steerable vehicle according to claim 34 further comprising means for absorbing shock exerted on said at least one ski attached to said at least one but not more than two rear wheel hub and spindle assemblies thereby damping shock, caused by said vehicle passing over rough terrain, between said at least one ski and said rear axle assembly.

38. The gravity driven steerable vehicle according to claim 28 wherein said means steering said gravity driven steerable vehicle comprises a steering system for steering said front axle assembly.

39. The gravity driven steerable vehicle according to claim 37 wherein said means steering said gravity driven steerable vehicle comprises a steering system for steering said front axle assembly.

40. The gravity driven steerable vehicle according to claim 28 wherein said means steering said gravity driven steerable vehicle comprises a steering system for steering said rear axle assembly.

41. The gravity driven steerable vehicle according to claim 37 wherein said means steering said gravity driven steerable vehicle comprises a steering system for steering said rear axle assembly.

42. The gravity driven steerable vehicle according to claim 38 wherein said means steering said gravity driven steerable vehicle further comprises a steering system for steering said rear axle assembly.

43. The gravity driven steerable vehicle according to claim 39 wherein said means steering said gravity driven steerable vehicle comprises a steering system for steering said rear axle assembly.

44. The gravity driven steerable vehicle according to claim 29 wherein said means for causing deceleration and halting of motion of said vehicle is at least one hydraulic brake mechanism braking said skiis assembled to said front wheel hub and spindle assemblies.

45. The gravity driven steerable vehicle according to claim 39 wherein said means for causing deceleration and halting of motion of said vehicle is at least one hydraulic brake mechanism braking said skiis assembled to said front wheel hub and spindle assemblies.

46. The gravity driven steerable vehicle according to claim 43 wherein said means for causing deceleration and halting of motion of said vehicle is at least one hydraulic brake mechanism braking said skiis assembled to said front wheel hub and spindle assemblies.

47. A gravity driven steerable vehicle for use on snow covered terrain comprising:
a chassis having a front portion, a rear portion, an underside and a top side;
a rider riding surface on said chassis top side configured to cause a rider on said rider riding surface to be oriented in a prone, face down, face forward position;
means for attaching a rear axle assembly substantially at said chassis rear portion;
means for mounting a front axle assembly substantially at said chassis front portion;
means for steering said gravity driven steerable vehicle by said rider when said rider is positioned on said rider riding surface;
two rear hub and spindle assemblies integral with said rear axle assembly, one rear hub and spindle assembly at each end of said rear axle assembly; and
two front hub and spindle assemblies integral with said front axle assembly, one front hub and spindle assembly at each end of said front axle assembly;
means for attaching one ski assembleable to each of said two rear hub and spindle assemblies and said two front hub and spindle assemblies;
means for causing said vehicle to be non-moving when said vehicle is unoccupied by a rider wherein said means for causing non-movement of unoccupied vehicle is at least one movement-limiting system for causing non-movement of an unoccupied vehicle or combination of any or all movement-limiting systems selected from a group consisting of weight detection of objects occupying said rider riding surface, temperature detection of objects occupying said rider riding surface, electrical current flow detection of level of current flow within at least two skin contact points associated with said rider; and
activation control mechanism for activating and deactivating said means for causing said vehicle to be non-moving.

48. The gravity driven steerable vehicle for use on snow covered terrain according to claim 47 further comprising means for causing deceleration and halting of motion of said vehicle when said vehicle has motion and being used by a rider on said rider riding surface.

49. The gravity driven steerable vehicle for use on snow covered terrain according to claim 47 further comprising means for harnessing the rider onto and into said rider riding surface when said rider is positioned on said vehicle.

50. The gravity driven steerable vehicle for use on snow covered terrain according to claim 48 further comprising means for harnessing the rider onto and into said rider riding surface when said rider is positioned on said vehicle.

51. The gravity driven steerable vehicle for use on snow covered terrain according to claim 47 further comprising means for absorbing shock exerted on said ski attached to said two front hub and spindle assemblies thereby damping shock, caused by said vehicle passing over rough terrain, between said front attached skiis and said front axle assembly.

52. The gravity driven steerable vehicle for use on snow covered terrain according to claim 49 further comprising means for absorbing shock exerted on said ski attached to said two front hub and spindle assemblies thereby damping shock, caused by said vehicle passing over rough terrain, between said front attached skiis and said front axle assembly.

53. The gravity driven steerable vehicle for use on snow covered terrain according to claim 50 further comprising means for absorbing shock exerted on said ski attached to said two front hub and spindle assemblies thereby damping shock, caused by said vehicle passing over rough terrain, between said front attached skiis and said front axle assembly.

54. The gravity driven steerable vehicle for use on snow covered terrain according to claim 53 further comprising means for absorbing shock exerted on said ski attached to each said two rear hub and spindle assemblies thereby damping shock caused by said vehicle passing over rough terrain, between said rear attached skiis and said rear axle assembly.

55. The gravity driven steerable vehicle for use on snow covered terrain according to claim 47 further comprising a combination rear roll bar and transport bail for protecting the rider and for transporting said vehicle using a means for lifting.
